(19) United States
(12) Patent Application Publication
(10) Pub. No.: US 2009/0092771 A1
(43) Pub. Date: Apr. 9, 2009

(54) CELLULOSE ACYLATE FILM, POLARIZING PLATE AND LIQUID CRYSTAL DISPLAY DEVICE

(75) Inventors: Katsumi Sasata, Kanagawa (JP); Takuya Inoue, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/913,568

(22) PCT Filed: Jun. 21, 2006
(86) PCT No.: PCT/JP2006/312836

§ 371 Date: Nov. 5, 2007

(30) Foreign Application Priority Data
Jun. 21, 2005 (JP) 2005-181060

(51) Int. Cl. C09K 19/00; B32B 23/00; G02B 1/11

(52) U.S. Cl. 428/1.31; 536/63; 359/601

(57) ABSTRACT

A cellulose acylate film that has: an in-plane orientation coefficient fxy and a thickness-direction orientation coefficient fxz falling within a range represented by following relationships; and an in-plane retardation Re (λ) falling within a range of 30 nm≦Re (590)≦200 nm and a thickness-direction retardation Rth (λ) falling within a range of 70 nm≦Rth (590)≦350 nm at 25° C., 60% RH:

|fxy|<0.15

|fxz|<0.15

wherein fxy and fxz are calculated from infrared absorption spectroscopy measurement data based on C═O expansion/contraction mode of a ester group, and wherein Re (λ) represents an in-plane retardation (Re) value (unit: nm) at a wavelength of λ nm; and Rth (λ) represents a thickness-direction retardation (Rth) value (unit: nm) at a wavelength of λ nm.

### TECHNICAL FIELD

The present invention relates to a cellulose acylate film and a polarizing plate and a liquid crystal display device comprising same.

### BACKGROUND ART

Liquid crystal display devices have been widely used for monitor for personal computer and cellular phone, television, etc. because they are advantageous in that they can operate at low voltage with low power consumption and are available in small size and thickness. These liquid crystal display devices have been proposed in various modes depending on the alignment of liquid crystal molecules in the liquid crystal cell. To date, TN mode, in which liquid crystal molecules are aligned twisted at about 90 degrees from the lower substrate to the upper substrate of the liquid crystal cell, has been a mainstream.

A liquid crystal display device normally comprises a liquid crystal cell, an optical compensation sheet and a polarizer. The optical compensation sheet is used to eliminate undesirable coloring of image or expand the viewing angle. As such an optical compensation sheet there is used a stretched birefringent film or a transparent film coated with a liquid crystal. For example, Japanese Patent No. 2587398 discloses a technique for the expansion of the viewing angle involving the application to a TN mode liquid crystal cell of an optical compensation sheet obtained by spreading a discotic liquid crystal over a triacetyl cellulose film, and then orienting and fixing the coat layer. However, liquid crystal display devices for TV use which are supposed to give a wide screen image that can be viewed at various angles have severe requirements for dependence on viewing angle. These requirements cannot be met even by the aforementioned approach. To this end, liquid crystal display devices of modes different from TN mode, including IPS (In-Plane Switching) mode, OCB (Optically Compensatory Bend) mode, VA (Vertically Aligned) mode, have been under study. In particular, VA mode has been noted as liquid crystal display device for TV use because it gives a high contrast image and can be produced in a relatively high yield.

A cellulose acylate film is normally characterized by a higher optical isotropy (lower retardation value) than other polymer films. Accordingly, it is normally practiced to use a cellulose acetate film in uses requiring optical isotropy such as polarizing plate.

On the contrary, the optical compensation sheet (retarder film) for liquid crystal display device is required to have optical anisotropy (high retardation value). In particular, the optical compensation sheet for VA mode is required to have a front retardation (Re) of from 30 to 200 nm and a thickness direction retardation (Rth) of from 70 to 400 nm. Accordingly, it has been usually practiced to use, as an optical compensation sheet, a synthetic polymer film having a high retardation value such as polycarbonate film and polysulfone film.

As mentioned above, it was an ordinary principle in the art of optical materials that when the polymer film is required to have optical anisotropy (high retardation value), a synthetic polymer film is used, while the polymer film is required to have optical isotropy (low retardation value), a cellulose acetate film is used.

European Patent Application Disclosure No. 911656 overthrows this conventional general principle and proposes a cellulose acylate film having a high retardation value that can be used also for purposes requiring optical anisotropy. In accordance with this proposal, an aromatic compound having at least two aromatic rings, particularly a compound having 1,3,5-triazine ring, is added to cellulose triacetate to be stretched in order to realize a cellulose triacetate film having a high retardation value.

It is generally known that a cellulose triacetate is a polymer material that can be difficulty stretched and provided with a high birefringence. However, when additives are oriented at the same time with stretching, it is possible to raise birefringence and realize a high retardation value. This film is advantageous in that it can act also as a protective layer for polarizing plate and thus can provide an inexpensive thin liquid crystal display device.

JP-A-2002-71957 discloses an optical film having as a substituent a C₂-C₄ acyl group that satisfies the numerical formulae 2.0≦A+B≦3.0 and A<2.4 at the same time supposing that the degree of substitution of acetyl group is A and the degree of substitution of propionyl group or butyryl group is B, wherein the refractive index Nx of the film in the direction of slow axis and the refractive index Ny of the film in the direction of fast axis at a wavelength of 590 nm satisfy the numerical formula 0.0005≦Nx−Ny≦0.0050.

JP-A-2003-270442 discloses a polarizing plate for use in VA mode liquid crystal display device, wherein the polarizing plate has a polarizer and an optically biaxial mixed aliphatic acid cellulose ester film which is disposed interposed between the liquid crystal cell and the polarizer.

The methods disclosed in the above references are advantageous in that an inexpensive thin liquid crystal display device can be obtained. In recent years, however, liquid crystal display devices have been more often used under high humidity. Therefore, the cellulose acylate films prepared by the above proposed techniques are disadvantageous in that they show a drop of optical compensation properties under such conditions. In particular, cellulose acylate films having a high Re retardation value or Rth retardation value prepared by the above proposed techniques are disadvantageous in that they show a change of Re retardation value or Rth retardation value and hence a change of optical compensation properties with humidity.

It has thus been desired to develop a film which shows little change of optical compensation properties with humidity and thus can provide an inexpensive thin liquid crystal display device.

### DISCLOSURE OF THE INVENTION

An aim of the invention is to provide an optical film having an excellent developability of in-plane retardation and thickness-direction retardation and little change of retardation value with environmental factors such as humidity. A second aim of the invention is to provide a liquid crystal display device having little change of viewing angle properties even with the change of atmospheric humidity and a polarizing plate for use in the liquid crystal display device.

In general, in order to prepare a film having a high retardation value, it is necessary that stretching or the like be effected to raise the orientation degree of the film. However, the inventors found that the higher the retardation value of the film thus prepared is, the greater is the change of optical compensation properties with atmospheric humidity. This is presumably because the film having polymer chains highly oriented therein shows a great change of orientation degree and hence a great change of retardation value with atmospheric change.

The inventors then made extensive studies taking into account the aforementioned circumstances. As a result, an idea came that when the absolute value of orientation degree of polymers in the film is kept low, the change of orientation degree with atmospheric humidity is reduced to reduce the change of optical properties. The inventors then found that the aforementioned aims of the invention can be accomplished by predetermining the orientation degree of cellulose acylate film to fall within a specific range. The invention has thus been worked out.

(1) A cellulose acylate film that has: an in-plane orientation coefficient fxy and a thickness-direction orientation coefficient fxz falling within a range represented by following relationships; and an in-plane retardation Re (λ) falling within a range of 30 nm≦Re (590)≦200 nm and a thickness-direction retardation Rth (λ) falling within a range of 70 nm≦Rth (590)≦350 nm at 25° C., 60% RH:

|fxy|<0.15

|fxz|<0.15

wherein fxy and fxz are calculated from infrared absorption spectroscopy measurement data based on C═O expansion/contraction mode of a ester group, and

wherein Re (λ) represents an in-plane retardation (Re) value (unit: nm) at a wavelength of λ nm; and

Rth (λ) represents a thickness-direction retardation (Rth) value (unit: nm) at a wavelength of λ nm.

(2) The cellulose acylate film as described in (1) above,

wherein a difference ΔRe(=Re10% RH-Re80% RH) between Re (590) (Re10% RH) at 25° C., 10% RH and Re (590) (Re80% RH) at 25° C., 80% RH and Re (590) (Re60% RH) at 25° C., 60% RH satisfy a relationship |ΔRe/Re60% RH|≦0.25, and

wherein a difference ΔRth (=Rth10% RH-Rth80% RH) between Rth (590) (Rth10% RH) at 25° C., 10% RH and Rth (590) (Rth80% RH) at 25° C., 80% RH and Rth (590) (Rth60% RH) at 25° C., 60% RH satisfy a relationship |ΔRth/Rth60% RH|≦0.25.

(3) The cellulose acylate film as described in (1) or (2) above, which comprises at least one retardation developer containing a rod-shaped compound or a disc-shaped compound in an amount of from 3% to 20% by mass based on a mass of the cellulose acylate film.

(4) The cellulose acylate film as described in any of (1) to (3) above, which is stretched at a draw ratio of from 1.01 to 1.3.

(5) The cellulose acylate film as described in any of (1) to (4) above, which is a film comprising a cellulose acylate obtained by substituting hydroxyl groups in a glucose unit constituting a cellulose by an acyl group having two or more carbon atoms,
wherein supposing that a degree of substitution of 2-position of a glucose unit by a hydroxyl group is DS2, a degree of substitution of 3-position of a glucose unit by a hydroxyl group is DS3 and a degree of substitution of 6-position of a glucose unit by a hydroxyl group is DS6, DS2, DS3 and DS6 satisfy following relationships (I) and (II).

2.55≦DS2+DS3+DS6≦2.85 (I)

DS6/(DS2+DS3+DS6)≧0.315 (II)

(6) The cellulose acylate film as described in any of (1) to (5) above, which comprises at least one of a plasticizer, an ultraviolet absorber and a peel accelerator.

(7) The cellulose acylate film as described in any of (1) to (6) above,

wherein the cellulose acylate film has a thickness of from 40 μm to 180 μm.

(8) A polarizing plate comprising:

a polarizer; and

at least one protective film for the polarizer,

wherein at least one of the at least one protective film is a cellulose acylate film as described in any of (1) to (7) above.

(9) The polarizing plate as described in (8) above, which further comprises at least one of a hard coat layer, an anti-glare layer and an anti-reflection layer provided on a surface of a protective film disposed on a side of the polarizing plate opposite to a liquid crystal cell.

(10) A liquid crystal display device comprising at least one of a cellulose acylate film as described in any (1) to (7) above and a polarizing plate as described in (8) or (9) above.

(11) The liquid crystal display device as described in (10) above, which is an OCB mode.

(12) The liquid crystal display device as described in (10) above, which is a VA mode.

(13) A VA mode liquid crystal display device comprising at least one of a cellulose acylate film as described in any of (1) to (7) above and a polarizing plate as described in (8) or (9) above.

(14) The VA mode liquid crystal display device as described in (12) or (13) above,

wherein the at least one of a cellulose acylate film as described in any of (1) to (7) above and a polarizing plate as described in (8) or (9) above is provided on a back light side.

### BRIEF DESCRIPTION OF THE DRAWING

FIG. 1 is a diagram illustrating four basic optical configurations in measurement using polarized ATR method;

FIG. 2 is a diagrammatic view illustrating one example of the method for sticking cellulose acylate film during the preparation of the polarizing plate of the invention;

FIG. 3 is a sectional view diagrammatically illustrating an example of the sectional structure of the polarizing plate of the invention; and

FIG. 4 is a sectional view diagrammatically illustrating one example of the sectional structure of the liquid crystal display device of the invention.

### BEST MODE FOR CARRYING OUT THE INVENTION

The invention will be further described hereinafter

The invention concerns a cellulose acylate film having an in-plane orientation coefficient fxy and a thickness-direction orientation coefficient fxz falling within the range represented by the following relationships:

|fxy|<0.15

|fxz|<0.15

in which fxy and fxz are calculated from infrared absorption spectroscopy measurement data based on C═O expansion/contraction mode of ester group, and an in-plane retardation Re (λ) falling within the range of 30 nm≦Re (590)≦200 nm and a thickness-direction retardation Rth (λ) falling within the range of 70 nm≦Rth (590)≦350 nm at 25° C. and 60% RH.

The in-plane orientation coefficient fxy and the thickness-direction orientation coefficient fxz can be evaluated by determining the ratio kx/ky, kx/kz and ky/kz of spatial absorption coefficient in the longitudinal direction (x), width direction (y) and thickness direction (z) using infrared spectroscopy. To this end, it is necessary that light beam polarized along the x, y and z axis directions be used to measure infrared absorption from which the ratio of absorption in the various directions are calculated. It is ideal to measure infrared absorption with light beams polarized independently in the x, y and z axis directions. In actuality, however, it is most difficult to measure infrared absorption in the thickness direction z. The polarized ATR method involves a procedure of measuring four absorption spectra in the x direction, y direction, xz direction (including both absorption components in the x axis direction and z axis direction) and yz direction (including both absorption components in the y axis direction and z axis direction), respectively, and then calculating the absorption coefficient in the x, y and z directions.

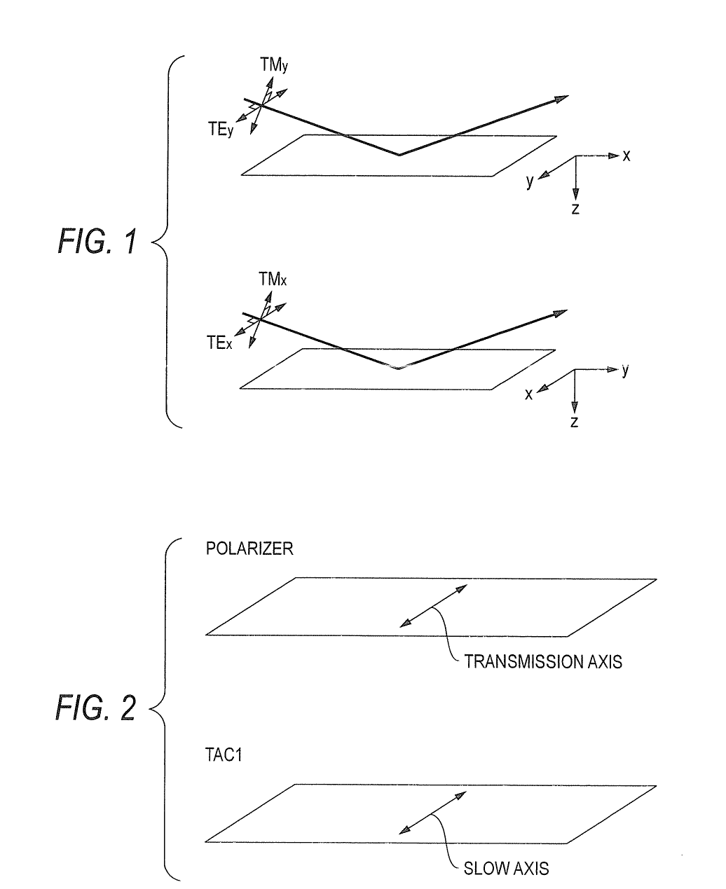

FIG. 1 depicts four basic optical configurations in measurement using polarized ATR method. With one of the planes of a sample as x, the other of the planes of the sample as y, the thickness of the sample z, the machine direction (MD) of a biaxially-stretched film as x and the direction perpendicular to x direction (transverse direction; TD) as y, vertical polarized light (s-polarization; transverse electric: TE) and horizontal polarized light (transverse magnetic: TM) are incident on the surface of incidence composed of incident light and reflected light using a wire grid polarizer. During this procedure, the x axis coincides with the direction of TE polarization (TEx, TMx). Subsequently, the sample is rotated at an angle of 90°. In other words, the x axis direction and the y axis direction are replaced with each other. Measurement is then made similarly (TEy, TMy). Supposing that the four absorption spectra thus obtained are A_{TEx}, A_{TMx}, A_{TEy} and A_{TMy}, respectively, the following relationships are established:

A_{TE}_{ₓ}=αkₓ

A_{TM}_{ₓ}=βk_{y}+γk_{z}

A_{TE}_{_{y}}=αk_{y}

A_{TM}_{_{y}}=βk_{y}+γk_{z}

wherein α, β and γ each are a constant dependent on the angle of incidence and the refractive index of the sample. These constants are calculated as follows, (Reference can be made to P. A. Floumoy, and W. J. Schaffers, “Spectrochimica Acta”, 22, 5 (1966), K. Palm, “Vib. Spectrosc.”, 6, 185, (1994))

$$α = \frac{4 {n}_{2}^{2}}{{n}_{1}^{2} {tan}^{2} θ \cdot \sqrt{1 - \frac{{n}_{2}^{2}}{{n}_{1}^{2} {sin}^{2} θ}} \cdot ( 1 - \frac{{n}_{2}^{2}}{{n}_{1}^{2}} )}$$

$$β = \frac{4 {n}_{2}^{2} ( 1 - \frac{{n}_{2}^{2}}{{n}_{1}^{2} {sin}^{2} θ} )}{{n}_{1}^{2} {tan}^{2} θ \cdot \sqrt{1 - \frac{{n}_{2}^{2}}{{n}_{1}^{2} {sin}^{2} θ}} \cdot ( 1 - \frac{{n}_{2}^{2}}{{n}_{1}^{2} {sin}^{2} θ} + {n}_{2}^{4} \frac{{cot}^{2} θ}{{n}_{1}^{4}} )}$$

$$γ = \frac{4 {n}_{2}^{2}}{{n}_{1}^{2} {tan}^{2} θ \cdot \sqrt{1 - \frac{{n}_{2}^{2}}{{n}_{1}^{2} {sin}^{2} θ}} \cdot ( 1 - \frac{{n}_{2}^{2}}{{n}_{1}^{2} {sin}^{2} θ} + {n}_{2}^{4} \frac{{cot}^{2} θ}{{n}_{1}^{4}} )}$$

wherein n₁ represents the refractive index of prism; n₂ represents the refractive index of sample; and θ represents the angle of incidence. The aforementioned equations can be used to calculate the spatial absorption coefficients kx, ky and kz in the aforementioned longitudinal direction (x), width direction (y) and thickness direction (z) of the sample.

$${k}_{x} = \frac{{A}_{{TE}_{x}}}{α}$$

$${k}_{y} = \frac{{A}_{{TE}_{y}}}{α}$$

$${k}_{z} = \{ ( \frac{{A}_{{TM}_{x}} - β {k}_{y}}{γ} ) + ( \frac{{A}_{{TM}_{y}} - β {k}_{x}}{γ} ) \} / 2$$

Therefore, infrared dichroic ratio can be represented as follows.

D_{xy}=kₓ/k_{y}

D_{xz}=kₓ/k_{z}

Dxy and Dxz each are 1100 for totally spatially isotropic unoriented sample. However, the greater the orientation is, the greater are these numerical values.

Other evaluation equations are monoaxial orientation coefficients (fxy, fxz), which allow more quantitative evaluation. These monoaxial orientation coefficients can be represented by the following equations. (Reference can be made to P. A. Floumoy, and W. J. Schaffers, “Spectrochimica Acta”, 22, 5 (1966))

$${f}_{xy} = ( \frac{{D}_{xy} - 1}{{D}_{xy} + 2} ) \cdot ( \frac{{D}_{0} + 2}{{D}_{0} - 1} )$$

$${f}_{xz} = ( \frac{{D}_{xz} - 1}{{D}_{xz} + 2} ) \cdot ( \frac{{D}_{0} + 2}{{D}_{0} - 1} )$$

wherein D₀ is cot 2δ in which δ is the angle of transition moment vector formed by molecular vibration with respect to the molecular axis. In order to strictly calculate δ, it is necessary that the direction of moment of molecular vibration be examined. In general, however, the vibrational mode parallel to the molecular axis or the vibrational mode perpendicular to the molecular axis may be selected. With the direction of the vibrational mode parallel to the molecular axis or the vibrational mode perpendicular to the molecular axis as 0° or 90°, respectively, calculation can be made to obtain sufficient data on orientation.

In some detail, a cellulose acylate film was subjected to calculation in a vibrational mode (δ=90°) in which the side chain ester group (C═O expansion/contraction, 1,747 cm⁻¹±10 cm⁻¹) vibrates in the direction perpendicular to the molecular axis. The base line was a straight line between the minimum value in the range of from 1,800 cm⁻¹ to 1,850 cm⁻¹ and the minimum value in the range of from 1,510 cm⁻¹ to 1,550 cm⁻¹.

For the measurement of infrared dichroic ratio, attenuated total reflection-infrared method (ATR-IR method) can be used. For the method for calculating infrared dichroic ratio, reference can be made to J. P. Hobbs, C. Se P. Sung, K. Krishan and S. Hill, “Macromolecules”, 16, 193, 1983.

Referring to the method for determining infrared dichroic ratio, light beam is incident on the cellulose acylate film in the direction parallel to the longitudinal direction. The absorbance developed when the polarized light is perpendicular to the surface of incidence (ATEx) and the absorbance developed when the polarized light is parallel to the surface of incidence (ATMx) are then determined. Subsequently, light beam is incident on the cellulose acylate film in the direction parallel to the width direction. ATEy and ATMy are then measured in the same manner as mentioned above. The measurements are then substituted in the aforementioned equations to calculate infrared dichroic ratios fxy and fxz.

In some detail, the following conditions for polarized ATR method are used.

Measuring instrument: FTS7000 (produced by Varian)

### Prism: Germanium

Torque between prism and sample: 30 cN·m
Area of tool for pressing sample against prism: 0.34 cm² (tool 10567, produced by Specac)
Angle of incidence: 45°
Number of reflection: 1
Resolution: 4 cm⁻¹

Calculation was made with the refractive index of the sample as 1.48. Calculation was also made with the refractive index of the prism (germanium) as 4.00. Vertical polarized light and horizontal polarized light were incident on the surface of incidence composed of light beam incident on the surface of the sample and light beam reflected by the surface of the sample using a wire grid polarizer. Under these conditions, FTIR-ATR spectra were then measured. This measurement was made with MD direction, vertical direction (width direction TD) and thickness direction set to x axis, y axis and z axis, respectively. In order to obtain a desired reproducibility of adhesion between sample and prism, a silicon rubber was provided interposed between the sample and the pressing tool.

The measurement was made at 25° C. in an atmosphere purged with nitrogen.

The range of in-plane orientation coefficient is preferably from more than −0.15 to less than 0.15, more preferably from more than −0.12 to less than 0.0, even more preferably from more than −0.08 to less than −0.02, and most preferably from more than −0.05 to less than −0.03. The range of thickness-direction orientation coefficient is preferably from more than −0.15 to less than 0.15, more preferably from more than −0.12 to less than 0.12, even more preferably from more than −0.10 to less than 0.10.

Retardation was measured by the incidence of light having a wavelength λ nm in the direction normal to the film using a Type KOBRA 21ADH birefringence meter (produced by Ouji Scientific Instruments Co. Ltd.). Rth(λ) was calculated from the assumed average refractive index value of 1.48 and the film thickness on the basis of retardation values measured in the total three directions, i.e., Re(λ), retardation value measured by the incidence of light having a wavelength λ nm in the direction inclined at an angle of +40° from the direction normal to the film with the in-plane slow axis as an inclined axis, retardation value measured by the incidence of light having a wavelength λ nm in the direction inclined at an angle of −40° from the direction normal to the film.

Re retardation value and Rth retardation value of the cellulose acylate film of the invention as optical properties satisfy the following relationships (V) and (VI), respectively, at 25° C. and 60% RH.

30 nm≦Re(590)≦200 nm (V)

70 nm≦Rth(590)≦350 nm (VI)

wherein Re (λ) represents the in-plane retardation (Re) value (unit: nm) at wavelength of λ nm and Rth (λ) represents the thickness-direction retardation (Rth) value (unit: nm) at a wavelength of λ nm.

Re(λ) can be measured by the incidence of light having a wavelength λ nm in the direction normal to the film using a birefringence meter such as Type KOBRA 21ADH birefringence meter (produced by Ouji Scientific Instruments Co. Ltd.). Rth(λ) can be calculated from the assumed average refractive index value of 1.48 and the film thickness on the basis of retardation values measured in the total three directions, i.e., Re(λ), retardation value measured by the incidence of light having a wavelength λ nm in the direction inclined at an angle of +40° from the direction normal to the film with the in-plane slow axis (judged from “KOBRA 21ADH”) as an inclined axis (rotary axis), retardation value measured by the incidence of light having a wavelength λ nm in the direction inclined at an angle of −40° from the direction normal to the film.

More preferably, the cellulose acylate film of the invention satisfies the following relationships (VII) and (VIII) at 25° C. and 65% RH.

46 nm≦Re(590)≦100 nm (VII)

160 nm≦Rth(590)≦350 nm (VIII)

Even more preferably, the cellulose acylate film of the invention satisfies the following relationships (IX) and (X) at 25° C. and 65% RH.

50 nm≦Re(590)≦80 nm (IX)

170 nm≦Rth(590)≦230 nm (X)

It is desirable for the optically-compensatory sheet comprising the cellulose acylate film of the invention and the VA mode liquid crystal display device comprising the polarizing plate of the invention that in addition to the relationships (VII) and (VIII), the following relationships (XI) and (XII) be satisfied at 25° C. and 60% RH.

Rth(590)=a−5.9Re(590)nm (XI)

520≦a≦600 nm (XII)

The central value of the intercept a of the straight line represented by the equation (XI) with the y axis is 560 nm. As the intercept a deviates downward from 560, the black brightness value of VA mode liquid crystal display device rises. In other words, the VA mode liquid crystal display device undergoes light leakage to lose black color display. On the other hand, as the intercept a deviates upward from 560, the VA mode liquid crystal display device is more subject to change of tint with the viewing angle to disadvantage. The equation (XII) depicts the tolerance of the value a. It is particularly desirable for VA mode liquid crystal display device, which comprises only one sheet of polarizing plate, that the relationships 55 nm≦Re (590)≦85 nm and 535 nm≦a≦585 nm be satisfied. Re (590) and Rth (590) change with Δnd of VA liquid crystal cell used. For example, when Δnd of the VA mode liquid crystal cell is 320 nm, Re (590) and Rth (590) are most preferably from 55 to 60 and from 185 to 275, respectively. When Δnd of the VA mode liquid crystal cell is 300 nm, Re (590) and Rth (590) are most preferably from 60 to 65 and from 160 to 240, respectively.

The dispersion of Re value over the total width is preferably ±5 nm, more preferably ±3 nm. Further, the dispersion of Rth value is preferably ±10 nm, more preferably ±5 nm. The longitudinal dispersion of Re value and Rth value preferably fall within the range of crosswise dispersion of Re value and Rth value.

Further, both the in-plane retardation Re and the thickness-direction retardation Rth of the cellulose acylate film of the invention are preferably little subject to change with humidity. In some detail, the change of Re value at 590 nm developed when the humidity at 25° C. changes from 10% RH to 80% RH is preferably 25% or less, more preferably 20% or less, even more preferably 15% or less of Re value measured at 60% RH. The change of Rth value at 590 nm developed when the humidity at 25° C. changes from 10% RH to 80% RH is preferably 25% or less, more preferably 20% or less, even more preferably 15% or less of Rth value measured at 60% RH.

In order to reduce the change of optical properties with humidity, various hydrophobic additives (e.g., plasticizer, retardation developer, ultraviolet absorber) may be used to reduce the moisture permeability or equilibrium water content of the film. These additives will be described hereinafter. The moisture permeability of the film is preferably from 400 g to 2,300 g per m² at 60° C. and 95% RH for 24 hours. The equilibrium water content of the film is preferably 3.4% or less as measured at 25° C. and 80% RH. The total amount of hydrophobic additives to be incorporated in the cellulose acylate film is preferably from 10% to 30%, more preferably from 12% to 25%, particularly preferably from 14.5% to 20% based on the mass of the cellulose acylate. (In this specification, mass ratio is equal to weight ratio.)

When the additives are so volatile or decomposable as to cause the change of mass or dimension of the film, the film can change in optical properties. Accordingly, the film which has aged at 80° C. and 90% RH for 48 hours preferably shows a mass change of 5% or less. Similarly, the film which has aged at 60° C. and 90% RH for 24 hours or at 90° C. and 3% RH for 24 hours preferably shows a dimensional change of within ±2%. In general, even a cellulose acylate film showing some dimensional or mass change is less subject to change of optical properties when it has a small photoelasticity coefficient. Accordingly, the photoelasticity coefficient of the film is preferably 50×10⁻¹³ cm²/dyn (5.0×10⁻¹⁰ m²/N) or less.

### <Cellulose Acylate>

The cellulose acylate which is used to advantage will be further described hereinafter. The β-1,4 bonding glucose unit constituting cellulose has a free hydroxyl group in the 2-, 3- and 6-positions. The cellulose acylate is a polymer obtained by esterifying some or whole of these hydroxyl groups by acyl group having two or more carbon atoms. The degree of substitution by acyl group means the percent esterification of hydroxyl group in cellulose in each of 2-, 3- and 6-positions (100% esterification means substitution degree of 1).

The total degree of substitution, i.e., DS2+DS3+DS6 is preferably from 2.00 to 3.00, more preferably from 2.20 to 2.90, particularly preferably from 2.55 to 2.85. Further, DS6/(DS2+DS3+DS6) is preferably 0.310 or more, particularly preferably 0.315 or more. DS2 is the degree of substitution of hydroxyl group in the 2-position of glucose unit by acyl group (hereinafter occasionally referred to as “2-position substitution degree”), DS3 is the degree of substitution of hydroxyl group in the 3-position of glucose unit by acyl group (hereinafter occasionally referred to as “3-position substitution degree”) and DS6 is the degree of substitution of hydroxyl group in the 6-position of glucose unit by acyl group (hereinafter occasionally referred to as “6-position substitution degree”).

The number of acyl groups to be incorporated in the cellulose acylate of the invention may be only one or two or more. When two or more acyl groups are used, one of the acyl groups is preferably an acetyl group. Supposing that the sum of the degree of substitution of hydroxyl group in the 2-position, 3-position and 6-position by acetyl group is DSA and the sum of the degree of substitution of hydroxyl group in the 2-position, 3-position and 6-position by acyl group other than acetyl group is DSB, the sum of DSA and DSB is preferably from 2.2 to 2.85, particularly preferably from 2.40 to 2.80. Further, DSB is preferably 1.70 or less, particularly preferably 1.0 or less. The degree of substitution of hydroxyl group in the 6-position preferably accounts for 28% or more, more preferably 30% or more, even more preferably 31% or more, particularly preferably 32% or more of DSB. Moreover, the sum of DSA and DSB in the 6-position of cellulose acylate is preferably 0.75 or more, more preferably 0.80 or more, particularly preferably 0.85 or more. The cellulose acylate having such acylate substitution properties exhibits an excellent solubility in a wide range of solvents and thus can provide a solution containing little insoluble matters. Further, a solution having a low viscosity and a good filterability can be prepared. As a result, the cellulose acylate film of the invention contains little foreign matters and thus can contain less so-called bright point foreign matters that leak brightness particularly when incorporated in a liquid crystal display device for black display.

The acyl group having 3 or more carbon atoms to be used in the invention may be an aliphatic or aromatic hydrocarbon group and is not specifically limited. Examples of the cellulose acylate employable herein include alkylcarbonyl ester, alkenylcarbonlyl ester, aromatic carbonylester and aromatic alkylcarbonylester of cellulose which may have substituted groups. Preferred examples of the acyl group include propionyl, butanoyl, keptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, and cinnamoyl. Preferred among these acyl groups are propionyl, butanoyl, dodecanoyl, octadecanoyl, t-butanoyl, oleoyl, benzoyl, naphthylcarbonyl, and cinnamoyl. Particularly preferred among these acyl groups are propionyl and butanoyl.

### <Method of Synthesizing Cellulose Acylate>

A basic principle of the method of synthesizing cellulose acylate is described in Migita et al, “Mokuzai Kagaku (Wood Chemistry)”, pp. 180-190, Kyoritsu Shuppan, 1968. A typical synthesis method involves liquid phase acetylation in the presence of a carboxylic anhydride-acetic acid-sulfuric acid catalyst.

In order to obtain the aforementioned cellulose acylate, a cellulose material such as cotton linter and wood pulp is pretreated with a proper amount of acetic acid, and then put in a carboxylated mixture which has been previously cooled to undergo esterification to synthesize a complete cellulose acylate (the sum of degrees of substitution by acyl in the 2-, 3- and 6-positions is almost 3.00). The aforementioned carboxylated mixture normally comprises acetic acid as a solvent, carboxylic anhydride as an esterifying agent and sulfuric acid as a catalyst. The carboxylic anhydride is normally used stoichiometrically in excess of the sum of the amount of cellulose reacting with the carboxylic anhydride and water content present in the system. The termination of the esterification reaction is followed by the addition of an aqueous solution of a neutralizing agent (e.g., carbonate, acetate or oxide of calcium, magnesium, iron, aluminum or zinc) for the purpose of hydrolyzing excessive carboxylic anhydride left in the system and neutralizing part of the esterification catalyst. Subsequently, the complete cellulose acylate thus obtained is kept at a temperature of from 50 to 90° C. in the presence of a small amount of an acetylation reaction catalyst (normally remaining sulfuric acid) to undergo saponification ripening that causes the conversion to cellulose acylate having a desired acyl substitution degree and polymerization degree. At the time when such a desired cellulose acylate is obtained, the catalyst remaining in the system is completely neutralized with a neutralizing agent mentioned above or the cellulose acylate solution is put in water or diluted sulfuric acid without being neutralized (alternatively, water or diluted sulfuric acid is put in the cellulose acylate solution) to separate the cellulose acylate which is then washed and stabilized or otherwise processed to obtain the aforementioned specific cellulose acylate.

In the aforementioned cellulose acylate film, the polymer component constituting the film is preferably made substantially of the aforementioned specific cellulose acylate. The “substantially” as used herein is meant to indicate 55% by mass or more (preferably 70% by mass or more, more preferably 80% by mass or more) of the polymer component.

The aforementioned cellulose acylate is preferably used in particulate form. 90% by mass or more of the particles used preferably have a particle diameter of from 0.5 to 5 mm. Further, 50% by mass or more of the particles used preferably have a particle diameter of from 1 to 4 mm. The particulate cellulose acylate preferably is in a form as much as close to sphere.

The polymerization degree of cellulose acylate which is preferably used in the invention is preferably from 200 to 700, more preferably from 250 to 550, even more preferably from 250 to 400, particularly from 250 to 350 as calculated in terms of viscosity-average polymerization degree. The average polymerization degree can be measured by an intrinsic viscosity method proposed by Uda et al (Kazuo Uda, Hideo Saito, “Seni Gakkaishi (JOURNAL OF THE SOCIETY OF FIBER SCIENCE AND TECHNOLOGY, JAPAN)”, No. 1, Vol. 18, pp. 105-120, 1962). For more details, reference can be made to JP-A-9-95538.

When low molecular components are removed, the resulting cellulose acylate has a raised average molecular mass (polymerization degree). However, the viscosity of the cellulose acylate is lower than that of ordinary acylates. Thus, as the aforementioned cellulose acylate, those freed of low molecular components are useful. Cellulose acylates having a small content of low molecular components can be obtained by removing low molecular components from cellulose acylates which have been synthesized by an ordinary method. The removal of the low molecular components can be carried out by washing the cellulose acylate with a proper organic solvent. In order to produce the cellulose acylate having a small content of low molecular components, the amount of the sulfuric acid catalyst in the acetylation reaction is preferably adjusted to a range of from 0.5 to 25 parts by mass based on 100 parts by mass of cellulose acylate. When the amount of the sulfuric acid catalyst falls within the above defined range, a cellulose acylate which is desirable also in the light of molecular mass distribution (uniform molecular mass distribution) can be synthesized. When used in the production of the cellulose acylate, the cellulose acylate preferably has a water content of 2% by mass or less, more preferably 1% by mass or less, particularly 0.7% by mass or less. A cellulose acylate normally contains water and is known to have a water content of from 2.5 to 5% by mass. In order to provide the cellulose acylate with a water content falling within this range in the invention, the cellulose acylate needs to be dried. The drying method is not specifically limited so far as the desired water content is attained.

For the details of cotton as starting material of the aforementioned cellulose acylate and its synthesis method, reference can be made to Kokai Giho No. 2001-1745, Mar. 15, 2001, Japan Institute of Invention and Innovation, pp. 7-12.

The cellulose acylate film of the invention can be obtained by filming a solution of the cellulose acylate and optionally additives in an organic solvent.

### <Additives>

The cellulose acylate solution according to the invention may comprise various additives such as plasticizer, ultraviolet absorber, deterioration inhibitor, retardation (optical anisotropy) developer, retardation (optical anisotropy) adjustor, particulate material, peel accelerator and infrared absorber incorporated therein at various preparation steps depending on the purpose. These additives may be in the form of solid material or oil-based material. In other words, these additives are not specifically limited in their melting point or boiling point. For example, ultraviolet absorbers having a melting point of 20° C. or less and 20° C. or more may be used in admixture with each other or a plasticizer. For details, reference can be made to JP-A-2001-151901. Examples of the peel accelerator include citric acid ethylesters. For the details of the infrared absorbers, reference can be made to JP-A-2001-194522. These additives may be added at any time during the process of preparing the dope. The step of adding these additives may be conducted at the final step in the process of preparing the dope. Further, the amount of these materials to be added is not specifically limited so far as their functions can be exhibited. In the case where the cellulose acylate film is formed in a multi-layer form, the kind and added amount of additives in the various layers may be different. As disclosed in JP-A-2001-151902 for example, these techniques have heretofore been known. The glass transition point Tg of the cellulose acylate film and the elastic modulus of the cellulose acylate measured by a tensile testing machine are preferably predetermined to a range of from 80° C. to 180° C. and a range of from 1,500 to 3,000 MPa, respectively, by properly selecting the kind and added amount of these additives.

As these additives there may be preferably used those disclosed in detail in Kokai Giho No. 2001-1745, Mar. 15, 2001, pp. 16 and after, Japan Institute of Invention and Innovation.

### <Plasticizer>

As the plasticizer there is preferably used phosphoric acid ester or carboxylic acid ester. The aforementioned plasticizer is more preferably selected from the group consisting of triphenyl phosphate (TPP), tricresyl phosphate (TCP), cresyl diphenyl phosphate, octyl diphenyl phosphate, biphenyl diphenyl phosphate (BDP), trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetylcitrate (OACTE), tributyl O-acetylcitrate (OACTB), acetyltriethyl citrate, acetyltributyl citrate, butyl oleate, methylacetyl ricinoleate, dibutyl sebacate, triacetin, tributylin, butylphthalyl glycolate, ethylphtlhalylethyl glycolate, methylphthalylethyl glycolate, and butylphthalylbutyl glycolate. Further, the aforementioned plasticizer is preferably selected from the group consisting of (di)pentaerythritolesters, glycerolesters and diglycerolesters.

### <Retardation Developer>

In the invention, a retardation developer is preferably used to realize a desired retardation value. The retardation developer to be used in the invention may be one made of a rod-shaped or disc-shaped compound. As the aforementioned rod-shaped or disc-shaped compound there may be used a compound having at least two aromatic rings.

The amount of the retardation developer made of a rod-shaped compound to be incorporated is preferably from 0.1 to 30 parts by mass, more preferably from 0.5 to 20 parts by mass based on 100 parts by mass of the polymer component containing cellulose acylate.

The disc-shaped retardation developer is preferably used in an amount of from 0.05 to 20 parts by mass, more preferably from 1.0 to 15 parts by mass, even more preferably from 3.0 to 10 parts by mass based on 100 parts by mass of the polymer component containing cellulose acylate.

The disc-shaped compound is superior to the rod-shaped compound in Rth retardation developability and thus is preferably used in the case where a remarkably great Rth retardation is required.

Two or more retardation developers may be used in combination.

The aforementioned retardation developer made of rod-shaped compound or disc-shaped compound preferably has a maximum absorption at a wavelength of from 250 to 400 nm and substantially no absorption in the visible light range.

The disc-shaped compound will be further described hereinafter. As the disc-shaped compound there may be used a compound having at least two aromatic rings.

The term “aromatic ring” as used herein is meant to include aromatic heterocyclic groups in addition to aromatic hydrocarbon rings.

The aromatic hydrocarbon ring is preferably a 6-membered ring (i.e., benzene ring) in particular.

The aromatic heterocyclic group is normally an unsaturated heterocyclic group. The aromatic heterocyclic group is preferably a 5-membered ring, 6-membered ring or 7-membered ring, more preferably a 5-membered ring or 6-membered ring. The aromatic heterocyclic group normally has the most numerous double bonds. As hetero atoms there are preferably used nitrogen atom, oxygen atom and sulfur atom, particularly nitrogen atom. Examples of the aromatic heterocyclic group include furane ring, thiophene ring, pyrrole ring, oxazole ring, isooxazole ring, thiazole ring, isothiazole ring, imidazole ring, pyrazole ring, furazane ring, triazole ring, pyrane ring, pyridine ring, pyridazine ring, pyrimidine ring, pyrazine ring, and 1,3,5-triazine ring.

Preferred examples of the aromatic ring include benzene ring, furane ring, thiophene ring, pyrrole ring, oxazole ring, thiazole ring, imidazole ring, triazole ring, pyridine ring, pyrimidine ring, pyrazine ring, and 1,3,5-triazine ring. Particularly preferred among these aromatic rings is 1,3,5-triazine ring. In some detail, as the disc-shaped compound there is preferably used one disclosed in JP-A-2001-166144.

The number of aromatic rings contained in the aforementioned disc-shaped compound is preferably from 2 to 20, more preferably from 2 to 12, even more preferably from 2 to 8, most preferably from 2 to 6.

Referring to the connection of two aromatic rings, (a) they may form a condensed ring, (b) they may be connected directly to each other by a single bond or (c) they may be connected to each other via a connecting group (No spiro bond cannot be formed due to aromatic ring). Any of the connections (a) to (c) may be established.

Preferred examples of the condensed ring (a) (formed by the condensation of two or more aromatic rings) include indene ring, naphthalene ring, azlene ring, fluorene ring, phenathrene ring, anthracene ring, acenaphthylene ring, biphenylene ring, naphthacene ring; pyrene ring, indole ring, isoindole ring, benzofurane ring, benzothiophene ring, benzotriazole ring, purine ring, indazole ring, chromene ring, quinoline ring, isoquinoline ring, quinolidine ring, quinazoline ring, cinnoline ring, quinoxaline ring, phthaladine ring, puteridine ring, carbazole ring, acridine ring, phenathridine, xanthene ring, phenazine ring, phenothiazine ring, phenoxathine ring, phenoxazine ring, and thianthrene ring. Preferred among these condensed rings are naphthalene ring, azlene ring, indole ring, benzooxazole ring, benzothiazole ring, benzoimidazole ring, benzotriazole ring, and quinoline ring.

The single bond (b) is preferably a bond between the carbon atom of two aromatic rings. Two or more aromatic rings may be connected via two or more single bonds to form an aliphatic ring or nonaromatic heterocyclic group between the two aromatic rings.

The connecting group (c), too, is preferably connected to the carbon atom of two aromatic rings. The connecting group is preferably an alkylene group, alkenylene group, alkinylene group, —CO—, —O—, —NH—, —S— or combination thereof. Examples of the connecting group comprising these groups in combination will be given below. The order of the arrangement of components in the following connecting groups may be inverted.

### c1: —CO—O—

### c2: —CO—NH—

c3: -alkylene-O—

### c4: —NH—CO—NH—

### c5: —NH—CO—O—

### c6: —O—CO—O—

### c7: —O-alkylene-O—

### c8: —CO-alkenylene-

### c9: —CO-alkenylene-NH—

### c10: —CO-alkenylene-O—

c11: -alkylene-CO—O-alkylene-O—CO-alkylene-

### c12: —O-alkylene-CO—O-alkylene-O—CO-alkylene-O—

### c13: —O—CO-alkylene-CO—O—

### c14: —NH—CO-alkenylene-

### c15: —O—CO-alkenylene-

The aromatic ring and connecting group may have substituents.

Examples of the substituents include halogen atoms (F, Cl, Br, I), hydroxyl groups, carboxyl groups, cyano groups, amino groups, sulfo groups, carbamoyl groups, sulfamoyl groups, ureido groups, alkyl groups, alkenyl groups, alkinyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, aliphatic substituted amino groups, aliphatic substituted carbamoyl groups, aliphatic substituted sulfamoyl groups, aliphatic substituted ureido groups, and nonaromatic heterocyclic groups.

The number of carbon atoms in the alkyl group is preferably from 1 to 8. A chain-like alkyl group is preferred to cyclic alkyl group. A straight-chain alkyl group is particularly preferred. The alkyl group preferably further has substituents (e.g., hydroxy group, carboxy group, alkoxy group, alkyl-substituted amino group). Examples of the alkyl group (including substituted alkyl group) include methyl group, ethyl group, n-butyl group, n-hexyl group, 2-hydroxyethyl group, 4-carboxybutyl group, 2-methoxyethyl group, and 2-diethylaminoethyl group.

The number of carbon atoms in the alkenyl group is preferably from 2 to 8. A chain-like alkinyl group is preferred to cyclic alkenyl group. A straight-chain alkenyl group is particularly preferred. The alkenyl group may further have substituents. Examples of the alkenyl group include vinyl group, allyl group, and 1-hexenyl group.

The number of carbon atoms in the alkinyl group is preferably from 2 to 8. A chain-like alkinyl group is preferred to cyclic alkinyl group. A straight-chain alkinyl group is particularly preferred. The alkinyl group may further have substituents. Examples of the alkinyl group include ethinyl group, 1-butinyl group, and 1-hexinyl group.

The number of carbon atoms in the aliphatic acyl group is preferably from 1 to 10. Examples of the aliphatic acyl group include acetyl group, propanoyl group, and butanoyl group.

The number of carbon atoms in the aliphatic acyloxy group is preferably from 1 to 10. Examples of the aliphatic acyloxy group include acetoxy group.

The number of carbon atoms in the alkoxy group is preferably from 1 to 8. The alkoxy group may further has substituents (e.g., alkoxy group). Examples of the alkoxy group (including substituted alkoxy groups) include methoxy group, ethoxy group, butoxy group, and methoxyethoxy group.

The number of carbon atoms in the alkoxycarbonyl group is preferably from 2 to 10. Examples of the alkoxycarbonyl group include methoxycarbonyl group, and ethoxycarbonyl group.

The number of carbon atoms in the alkoxycarbonylamino group is preferably from 2 to 10. Examples of the alkoxycarbonylamino group include methoxycarbonylamino group, and ethoxycarbonylamino group.

The number of carbon atoms in the alkylthio group is preferably from 1 to 12. Examples of the alkylthio group include methylthio group, ethylthio group, and octylthio group.

The number of carbon atoms in the alkylsulfonyl group is preferably from 1 to 8. Examples of the alkylsulfonyl group include methanesulfonyl group, and ethanesulfonyl group.

The number of carbon atoms in the aliphatic amide group is preferably from 1 to 10. Examples of the aliphatic amide group include acetamide group.

The number of carbon atoms in the aliphatic sulfonamide group is preferably from 1 to 8. Examples of the aliphatic sulfonamide group include methanesulfonamide group, butanesulfonamide group, and n-octanesulfonamide group.

The number of carbon atoms in the aliphatic substituted amino group is preferably from 1 to 10. Examples of the aliphatic substituted amino group include dimethylamino group, diethylamino group, and 2-carboxyethylamino group.

The number of carbon atoms in the aliphatic substituted carbamoyl group is preferably from 2 to 10. Examples of the aliphatic substituted carbamoyl group include methylcarbamoyl group, and diethylcarbamoyl group.

The number of carbon atoms in the aliphatic substituted sulfamoyl group is preferably from 1 to 8. Examples of the aliphatic substituted sulfamoyl group include methylsulfamoyl group, and diethylsulfamoyl group.

The number of carbon atoms in the aliphatic substituted ureido group is preferably from 2 to 10. Examples of the aliphatic substituted ureido group include methylureido group.

Examples of the nonaromatic heterocyclic group include piperidino group, and morpholino group.

The molecular mass of the retardation developer made of disc-shaped compound is preferably from 300 to 800.

In the invention, a rod-shaped compound having a linear molecular structure may be preferably used besides the aforementioned disc-shaped compounds. The term “linear molecular structure” as used herein is meant to indicate that the molecular structure of the rod-shaped compound which is most thermodynamically stable is linear. The most thermodynamically stable structure can be determined by crystallographic structure analysis or molecular orbital calculation. For example, a molecular orbital calculation software (e.g., WinMOPAC2000, produced by Fujitsu Co., Ltd.) may be used to effect molecular orbital calculation, making it possible to determine a molecular structure allowing the minimization of heat formation of compound. The term “linear molecular structure” as used herein also means that the most thermodynamically stable molecular structure thus calculated forms a main chain at an angle of 140 degrees or more.

The rod-shaped compound is preferably one having at least two aromatic rings. As the rod-shaped compound having at least two aromatic rings there is preferably used a compound represented by the following general formula (1):

Ar¹-L¹-Ar² (1)

wherein Ar¹ and Ar² each independently represents an aromatic ring.

Examples of the aromatic ring employable herein include aryl groups (aromatic hydrocarbon group), substituted aryl groups, and substituted aromatic heterocyclic groups.

The aryl group and substituted aryl group are preferred to the aromatic heterocyclic group and substituted aromatic heterocyclic group. The heterocyclic group in the aromatic heterocyclic group is normally unsaturated. The aromatic heterocyclic group is preferably a 5-membered ring, 6-membered ring or 7-membered ring, more preferably a 5-membered ring or 6-membered ring. The aromatic heterocyclic group normally has the most numerous double bonds. The hetero atom is preferably nitrogen atom, oxygen atom or sulfur atom, more preferably nitrogen atom or sulfur atom.

Preferred examples of the aromatic ring in the aromatic group include benzene ring, furane ring, thiophene ring, pyrrole ring, oxazole ring, thiazole ring, imidazole ring, triazole ring, pyridine ring, pyrimidine ring, and pyrazine ring. Particularly preferred among these aromatic rings is benzene ring.

Examples of the substituents on the substituted aryl group and substituted aromatic heterocyclic group include halogen atoms (F, Cl, Br, I), hydroxyl groups, carboxyl groups, cyano groups, amino groups, alkylamino groups (e.g., methylamino group, ethylamino group, butylamino group, dimethylamino group), nitro groups, sulfo groups, carbamoyl groups, alkylcarbamoyl groups (e.g., N-methylcarbamoyl group, N-ethylcarbamoyl group, N,N-dimethylcarbamoyl group), sulfamoyl groups, alkylsulfamoyl groups (e.g., N-methylsulfamoyl group, N-ethylsulfamoyl group, N,N-dimethylsulfamoyl group), ureido groups, alkylureido groups (e.g., N-methylureido group, N,N-dimethylureido group, N,N,N′-trimethyl ureido group), alkyl groups (e.g., methyl group, ethyl group, propyl group, butyl group, pentyl group, heptyl group, octyl group, isopropyl group, s-butyl group, t-amyl group, cyclohexyl group, cyclopentyl group), alkenyl groups (e.g., vinyl group, allyl group, hexenyl group), alkinyl groups (e.g., ethinyl group, butinyl group), acyl groups (e.g., formyl group, acetyl group, butyryl group, hexanoyl group, lauryl group), acyloxy groups (e.g., acetoxy group, butyryloxy group, hexanoyloxy group, lauryloxy group), alkoxy groups (e.g., methoxy group, ethoxy group, propoxy group, butoxy group, pentyloxy group, heptyloxy group, octyloxy group), aryloxy groups (e.g., phenoxy group), alkoxycarbonyl groups (e.g., methoxycarbonyl group, ethoxycarbonyl group, propoxycarbonyl group, butoxycarbonyl group, pentyloxycarbonyl group, heptyloxycarbonyl group), aryloxycarbonyl groups (e.g., phenoxycarbonyl group), alkoxycarbonylamino groups (e.g., butoxycarbonylamino group, hexyloxycarbonylamino group), alkylthio groups (e.g., methylthio group, ethylthio group, propylthio group, butylthio group, pentylthio group, heptylthio group, octylthio group), arylthio groups (e.g., phenylthio group), alkylsulfonyl groups (e.g., methyl sulfonyl group, ethylsulfonyl group, propylsulfonyl group, butylsulfonyl group, pentylsulfonyl group, heptylsulfonyl group, octylsulfonyl group), amide groups (e.g., acetamide group, butylamide group, hexylamide group, laurylamide group), and nonaromatic heterocyclic groups (e.g., morpholyl group, pyradinyl group).

Examples of the substituents on the substituted aryl group and substituted aromatic heterocyclic group include halogen atoms, cyano groups, carboxyl groups, hydroxyl groups, amino groups, alkyl-substituted amino groups, acyl groups, acyloxy groups, amide groups, alkoxycarbonyl groups, alkoxy groups, alkylthio groups, and alkyl groups.

The alkyl moiety and alkyl group in the alkylamino group, alkoxycarbonyl group, alkoxy group and alkylthio group may further have substituents. Examples of the substituents on the alkyl moiety and alkyl group include halogen atoms, hydroxyl groups, carboxyl groups, cyano groups, amino groups, alkylamino groups, nitro groups, sulfo groups, carbamoyl groups, alkylcarbamoyl groups, sulfamoyl groups, alkylsulfamoyl groups, ureido groups, alkylureido groups, alkenyl groups, alkinyl groups, acyl groups, acyloxy groups, acylamino groups, alkoxy groups, aryloxy groups, alkoxycarbonyl groups, aryloxycarbonyl groups, alkylthio groups, arylthio groups, alkylsulfonyl groups, amide groups, and nonaromatic heterocyclic groups. Preferred among these substituents on the alkyl moiety and alkyl group are halogen atoms, hydroxyl groups, amino groups, alkylamino groups, acyl groups, acyloxy groups, acylamino groups, and alkoxy groups.

In the general formula (1), L¹ represents a divalent connecting group selected from the group consisting of groups composed of alkylene group, alkenylene group, alkinylene group, —O—, —CO— and combination thereof.

The alkylene group may have a cyclic structure. The cyclic alkylene group is preferably cyclohexylene, particularly 1,4-cyclohexylene. As the chain-like alkylene group, a straight-chain alkylene is preferred to a branched alkylene.

The number of carbon atoms in the alkylene group is preferably from 1 to 20, more preferably from 1 to 15, even more preferably from 1 to 10, even more preferably from 1 to 8, most preferably from 1 to 6.

The alkenylene group and alkinylene group preferably has a chain-like structure rather than cyclic structure, more preferably a straight-chain structure than branched chain-like structure.

The number of carbon atoms in the alkenylene group and alkinylene group is preferably from 2 to 10, more preferably from 2 to 8, even more preferably from 2 to 6, even more preferably from 2 to 4, most preferably 2 (vinylene or ethinylene).

The number of carbon atoms in the arylene group is preferably from 6 to 20, more preferably from 6 to 16, even more preferably from 6 to 12.

In the molecular structure of the general formula (1), the angle formed by Ar¹ and Ar² with L¹ interposed therebetween is preferably 140 degrees or more.

The rod-shaped compound is more preferably a compound represented by the following general formula (2):

Ar¹-L²-X-L³-Ar² (2)

wherein Ar¹ and Ar² each independently represents an aromatic group. The definition and examples of the aromatic group are similar to that of Ar¹ and Ar² in the general formula (1).

In the general formula (2), L² and L³ each independently represents a divalent connecting group selected from the group consisting of groups formed by alkylene group, —O—, —CO— and combination thereof.

The alkylene group preferably has a chain-like structure rather than cyclic structure, more preferably a straight-chain structure rather than branched chain-like structure.

The number of carbon atoms in the alkylene group is preferably from 1 to 10, more preferably from 1 to 8, even more preferably from 1 to 6, even more preferably from 1 to 4, most preferably 1 or 2 (methylene or ethylene).

L² and L³ each are preferably —O—CO— or —CO—O— in particular.

In the general formula (2), X represents 1,4-cyclohexylene, vinylene or ethinylene.

Specific examples of the compound represented by the general formula (1) or (2) will be given below.

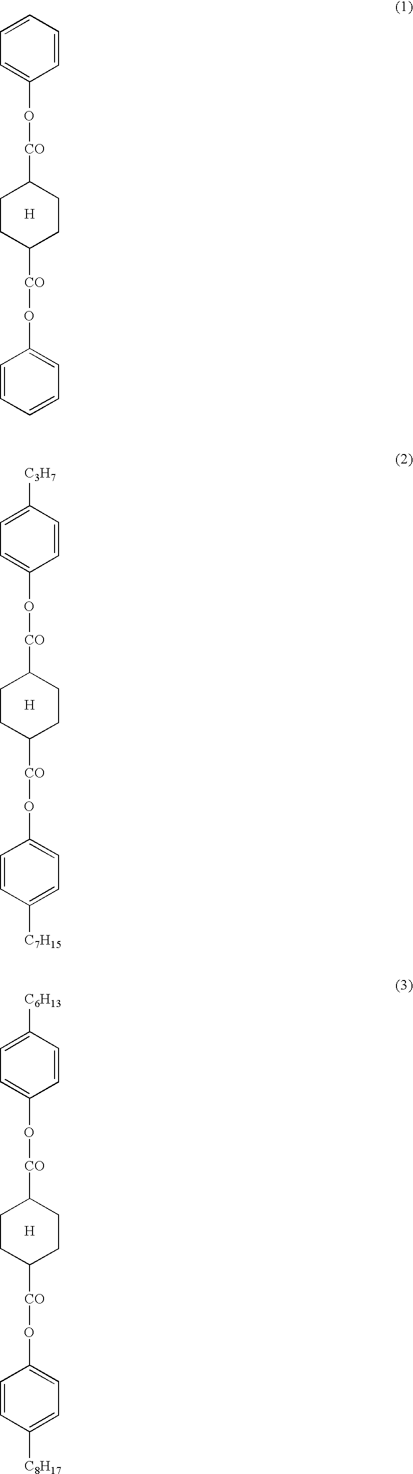

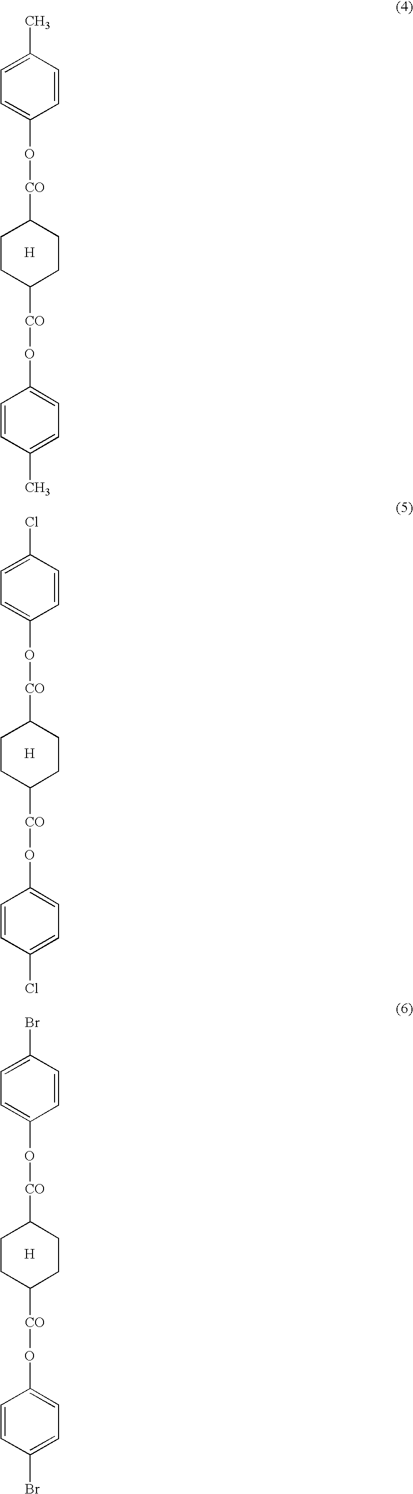

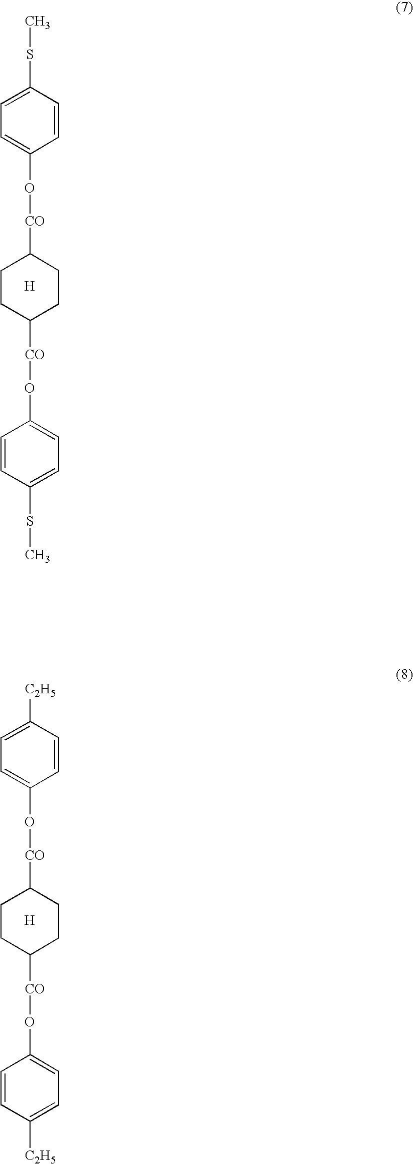

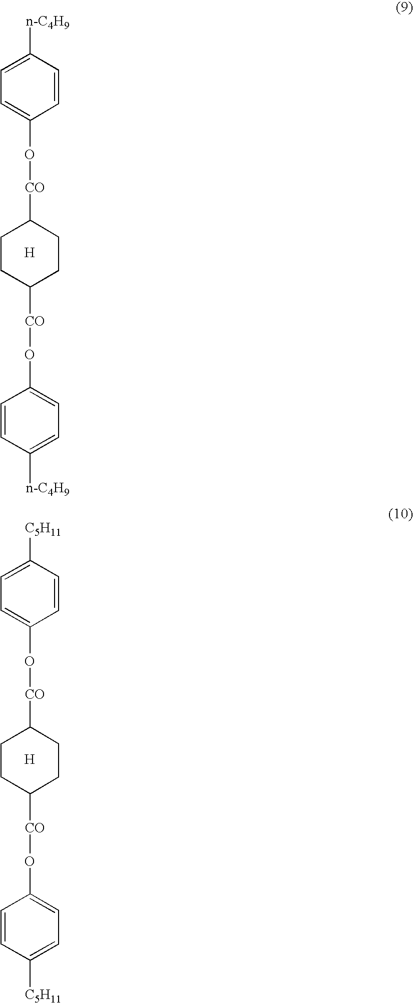

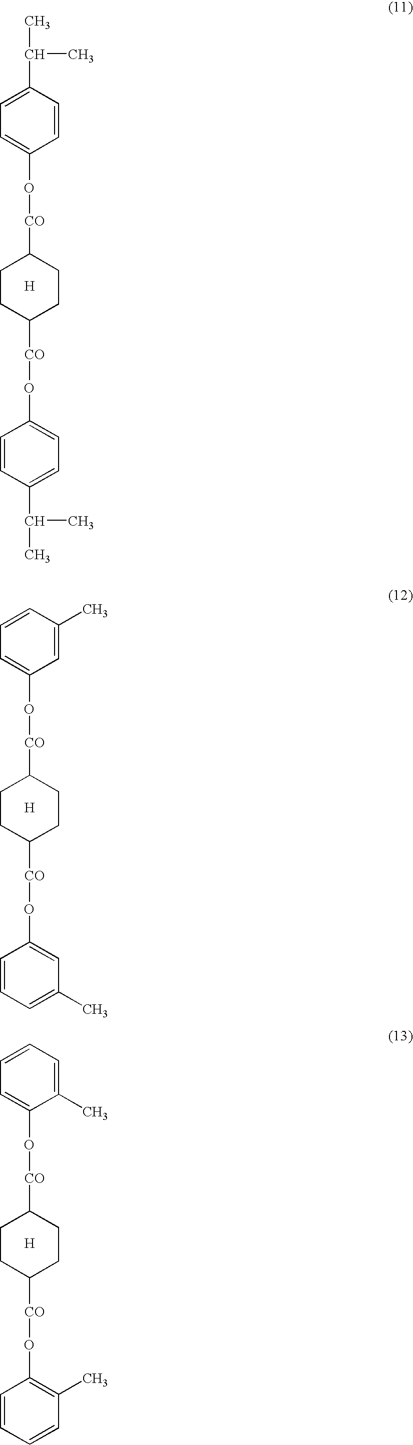

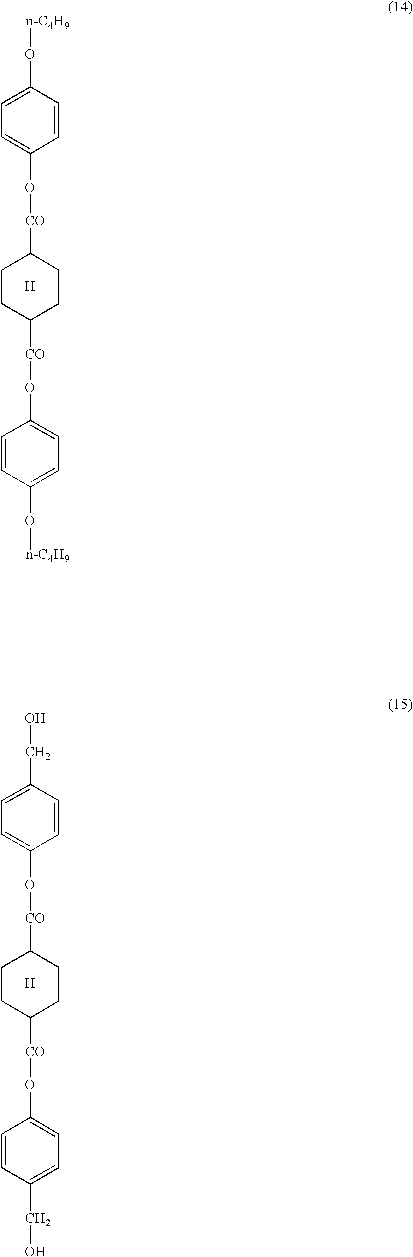

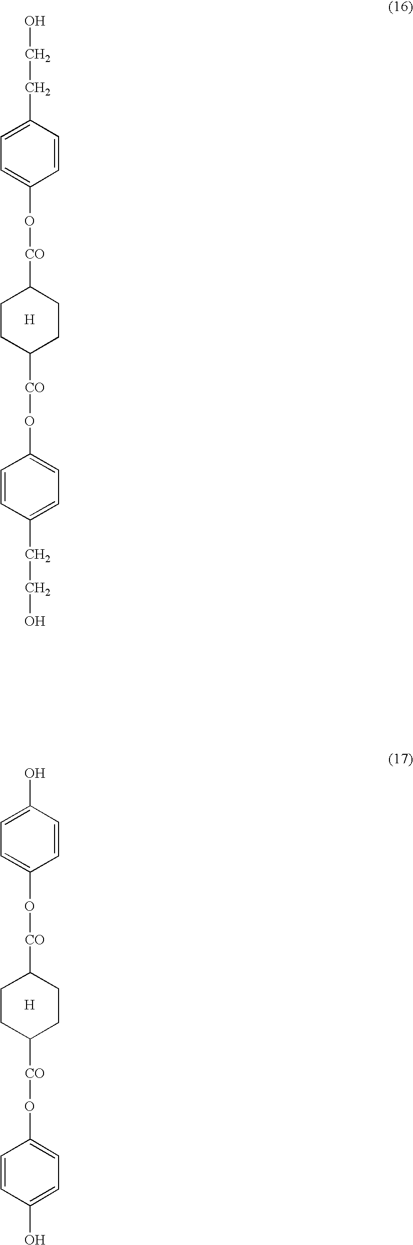

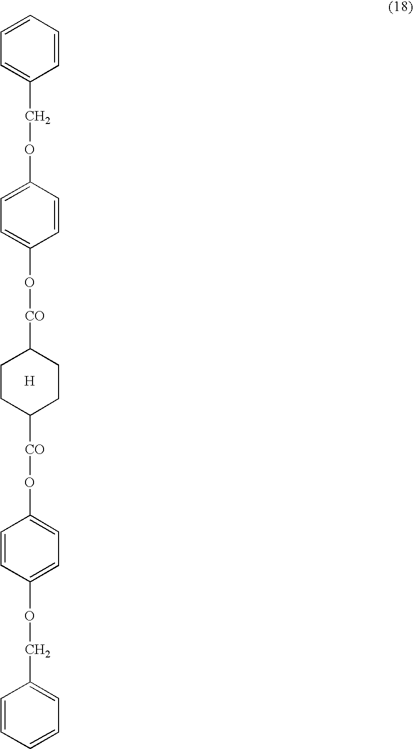

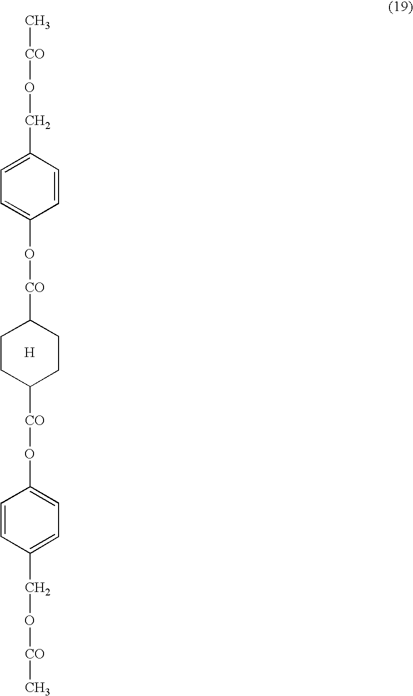

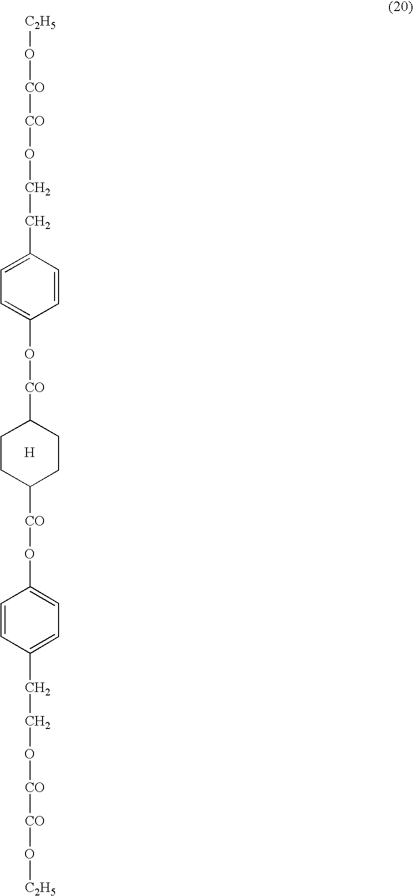

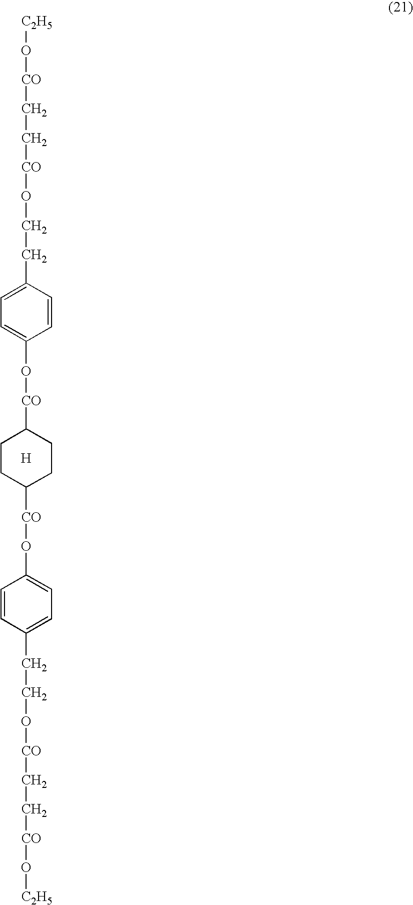

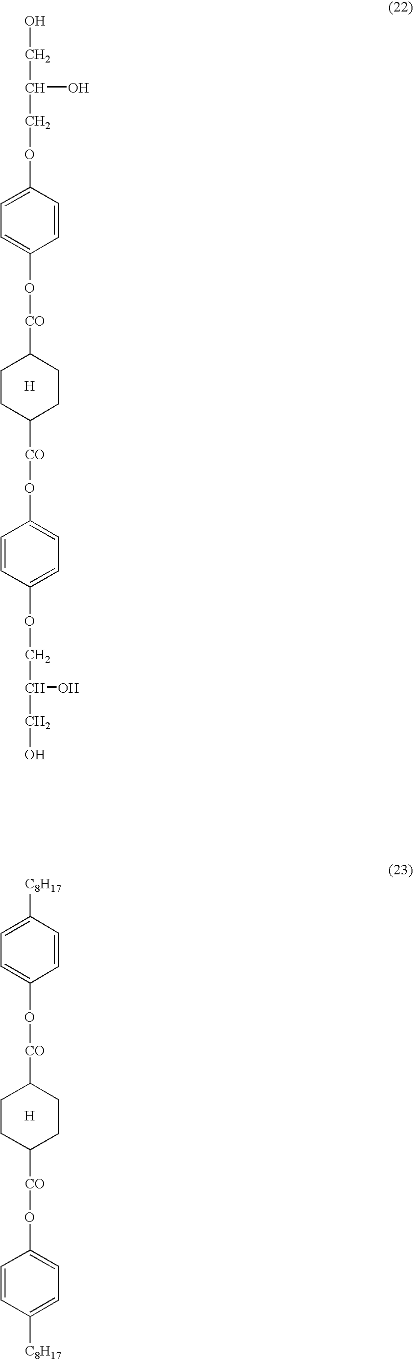

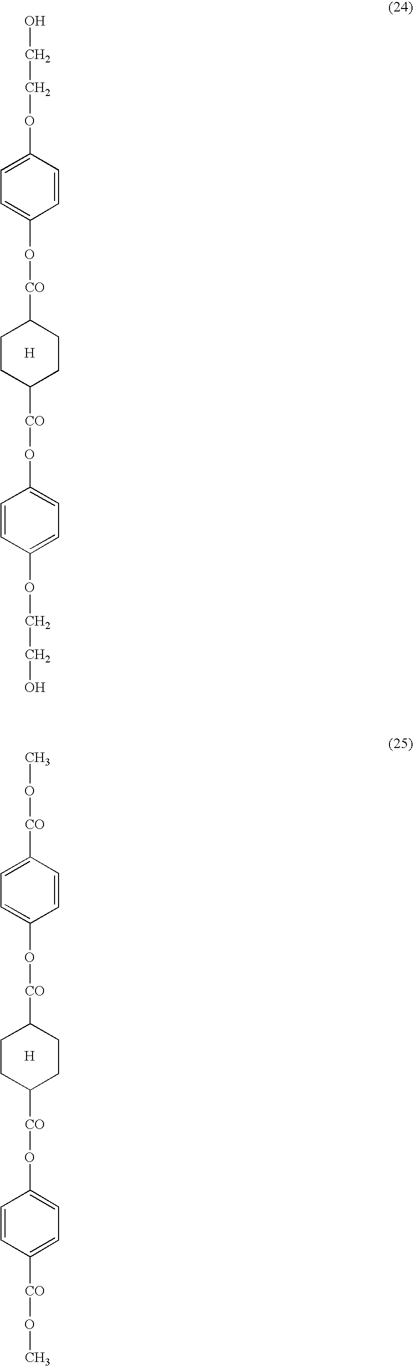

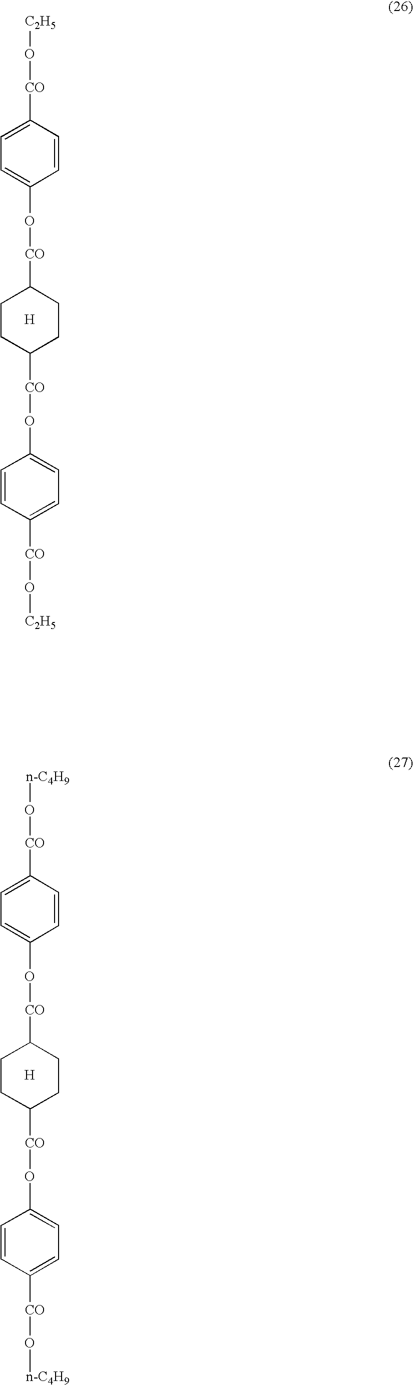

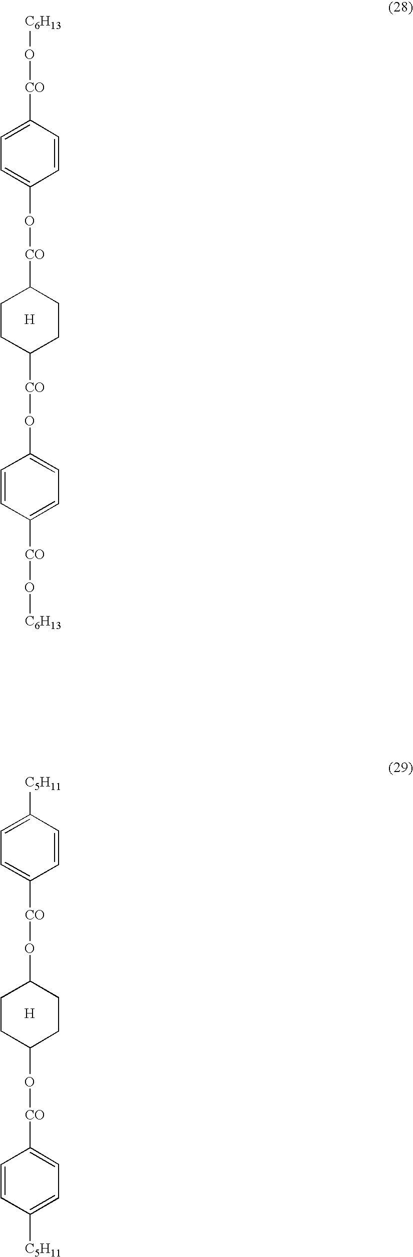

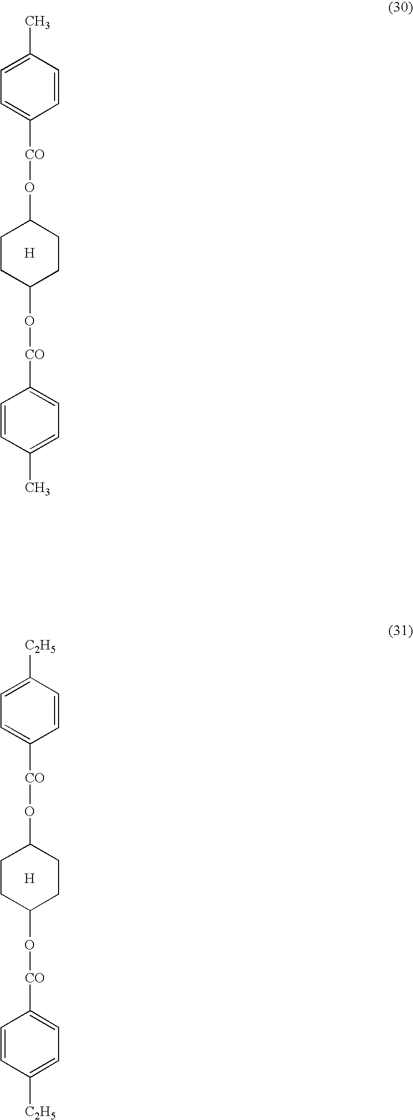

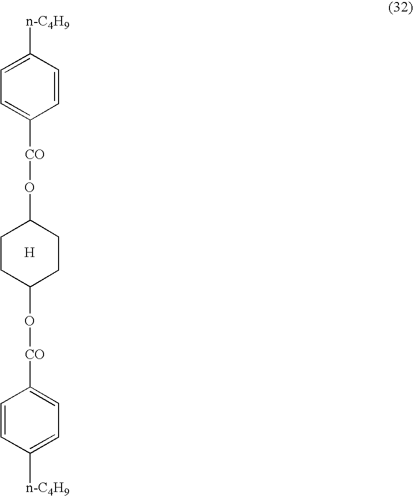

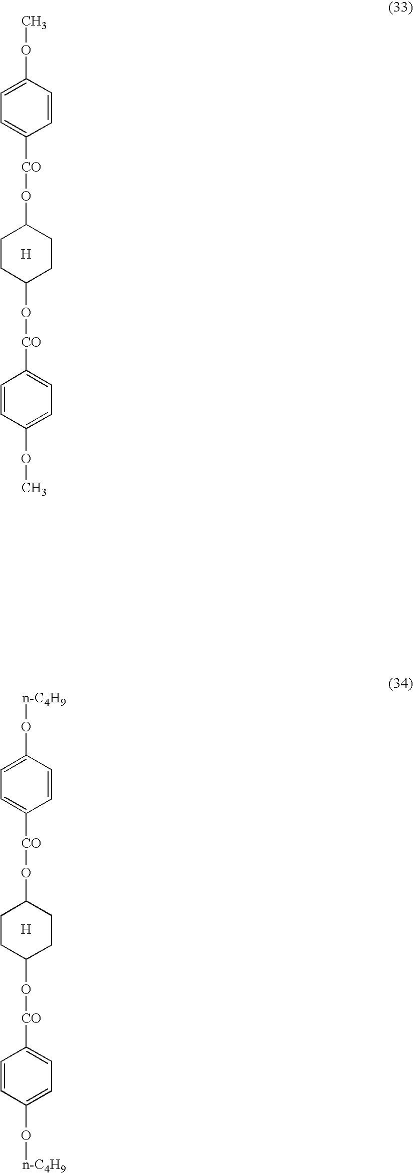

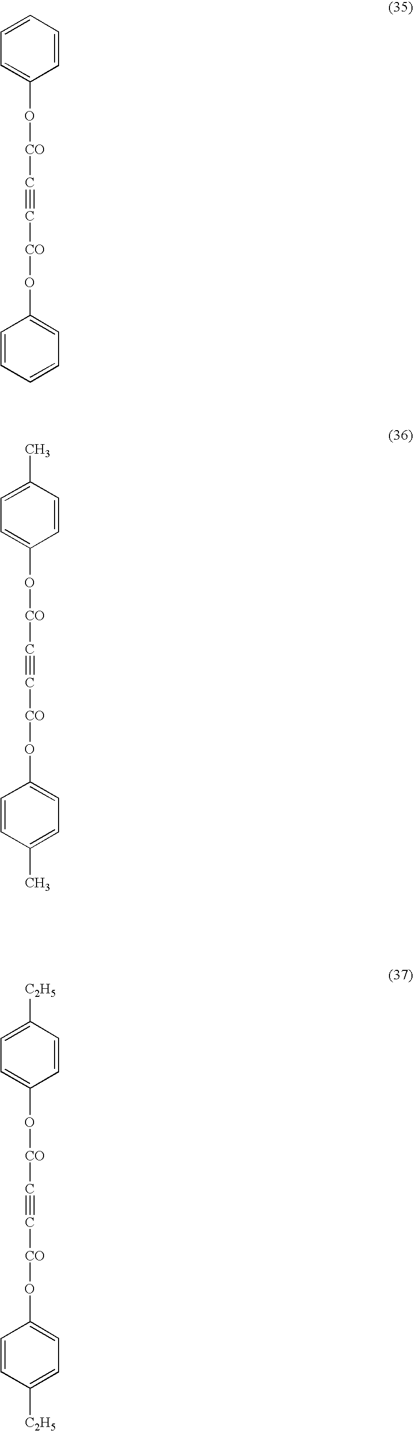

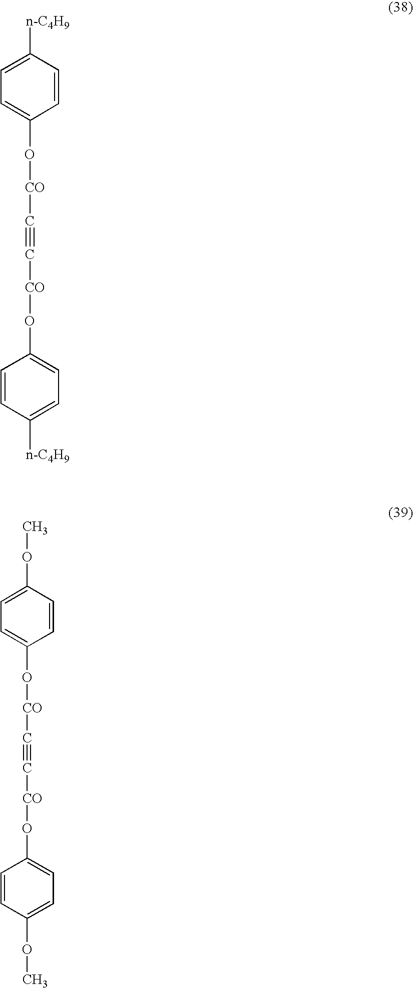

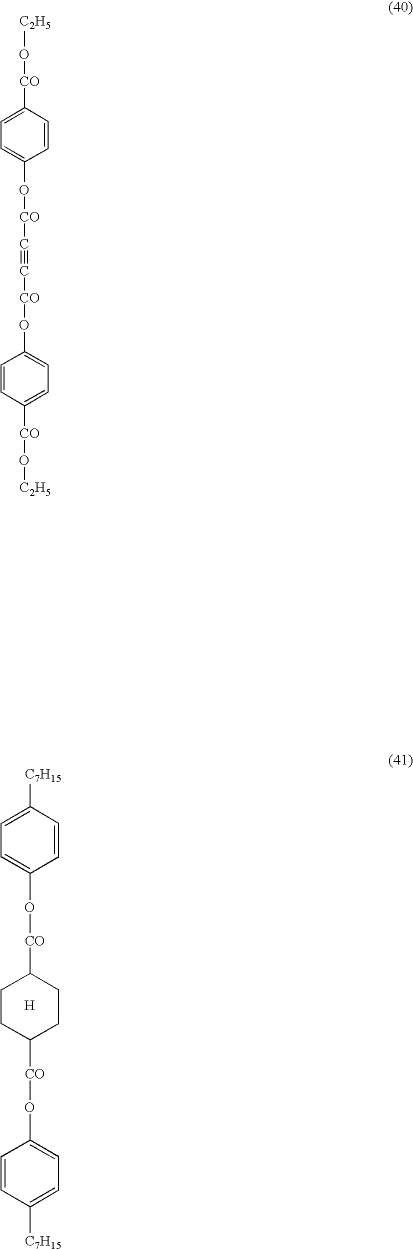

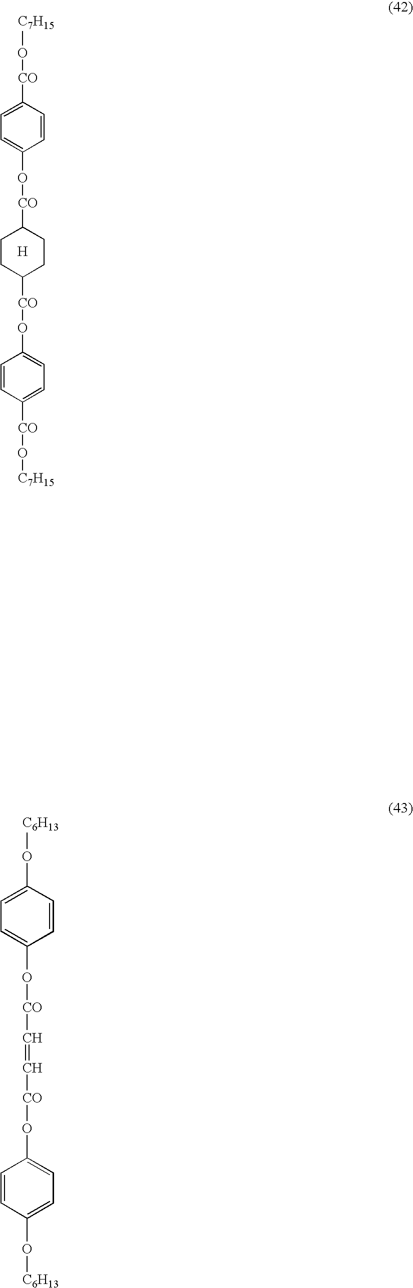

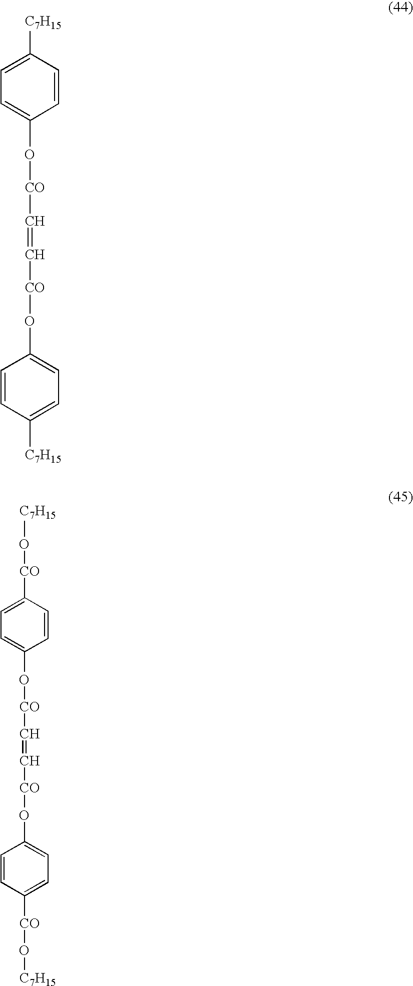

The specific examples (1) to (34), (41) and (42) each have two asymmetric carbon atoms, respectively, in the 1-position and the 4-position of cyclohexane ring. However, the specific examples (1), (4) to (34), (41) and (42) have a symmetric meso type molecular structure and thus have no optical isomers (optical activity) but have only geometric isomers (trans type and cis type). A trans type (1-trans) and a cis type (1-cis) of the specific example (1) will be shown below.

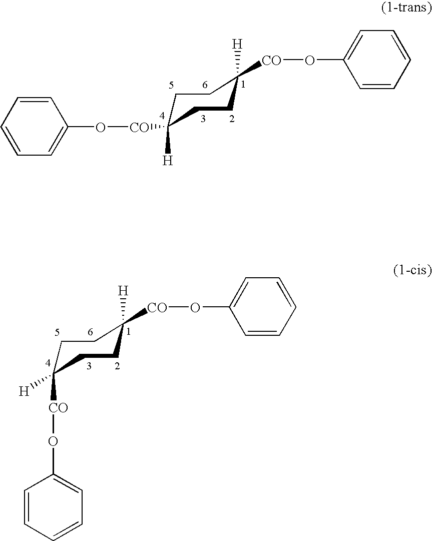

As previously mentioned, the rod-shaped compound preferably has a linear molecular structure. For this reason, the trans type rod-shaped compound is preferred to the cis type rod-shaped compound.

The specific examples (2) and (3) have optical isomers (four isomers in total) in addition to geometric isomers. Referring to geometric isomers, the trans type compound is preferred to the cis type compound as in the aforementioned case. There is nothing to choose among these optical isomers. Any of D, L and racemates may be used.

In the specific examples (43) to (45), the central vinylene bonds are classified as trans type and cis type. For the same reason as mentioned above, the trans type compound is preferred to the cis type compound.

Other preferred compounds will be given below.

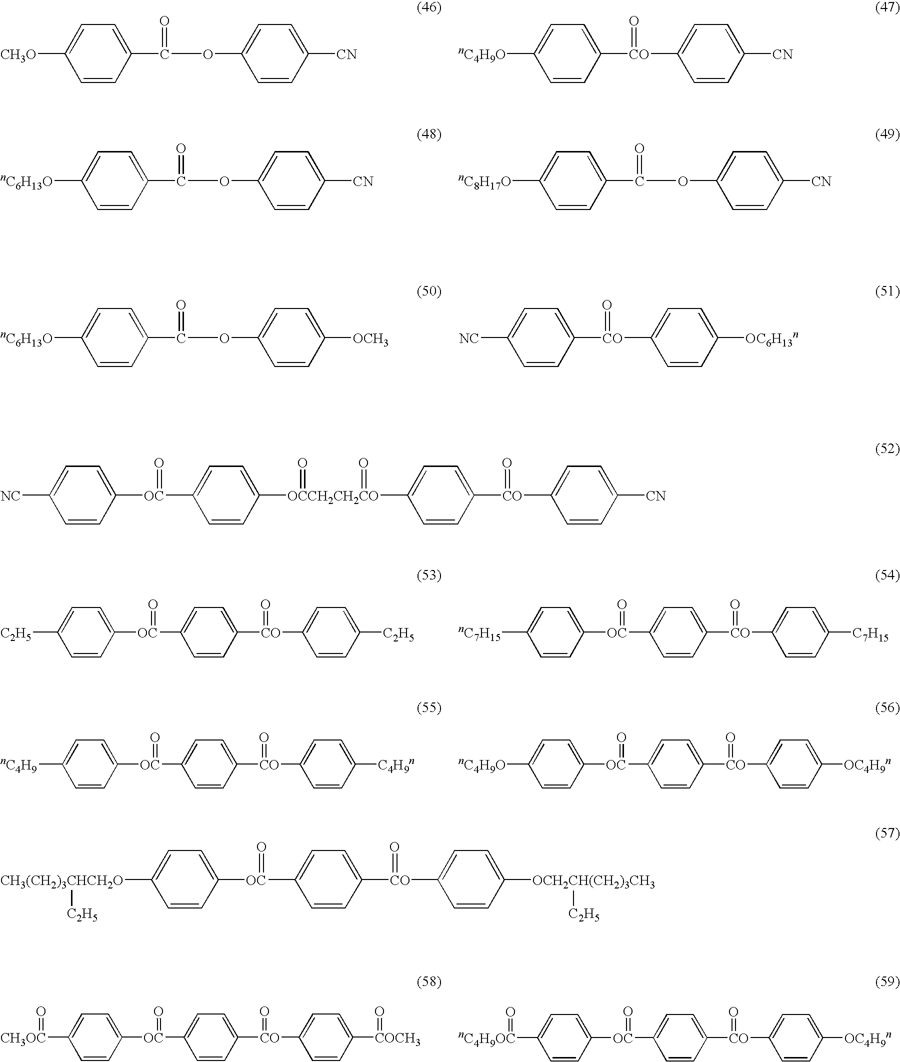

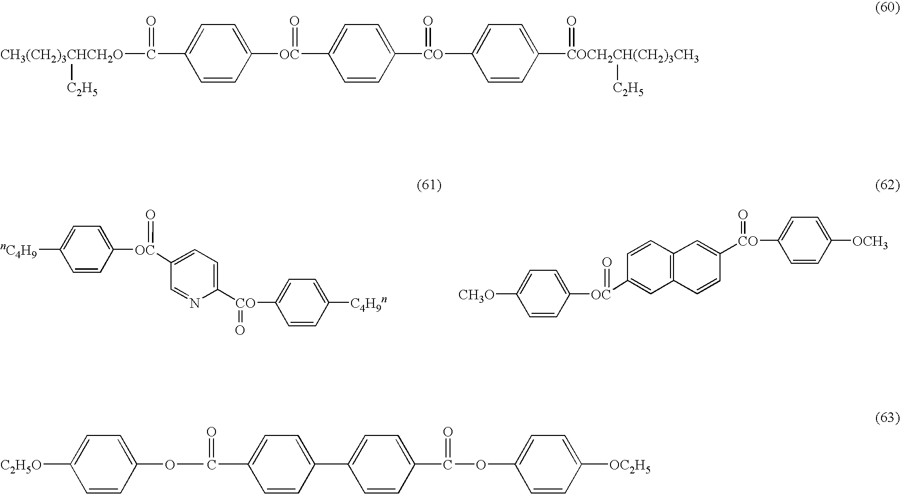

Two or more rod-shaped compounds having a maximum absorption wavelength (λmax) of shorter than 250 nm in the ultraviolet absorption spectrum of solution may be used in combination.

The rod-shaped compound can be synthesized by any method disclosed in literatures such as “Mol. Cryst. Liq. Cryst.”, vol. 53, page 229, 1979, “Mol. Cryst. Liq. Cryst.”, vol. 89, page 93, 1982, “Mol. Cryst. Liq. Cryst.”, vol. 145, page 11, 1987, “Mol. Cryst. Liq. Cryst.”, vol. 170, page 43, 1989, “J. Am. Chem. Soc.”, vol. 113, page 1, 349, 1991, “J. Am. Chem. Soc.”, vol. 118, page 5, 346, 1996, “J. Am. Chem. Soc.”, vol. 92, page 1, 582, 1970, “J. Org. Chem.”, vol. 40, page 420, 1975, and “Tetrahedron”, vol. 48, No. 16, page 3, 437, 1992.

The added amount of the retardation developer is preferably from 1 to 30% by mass, more preferably from 3 to 20% by mass based on the mass of the polymer.

### <Ultraviolet Absorber>

As the ultraviolet absorber there may be used an arbitrary kind of ultraviolet absorber depending on the purpose. Examples of the ultraviolet absorber employable herein include salicylic acid ester-based absorbers, benzophenone-based absorbers, benzotriazole-based absorbers, benzoate-based absorbers, cyano acrylate-based absorbers, and nickel complex salt-based absorbers. Preferred among these ultraviolet absorbers are benzophenone-based absorbers, benzotriazole-based absorbers, and salicylic acid ester-based absorbers. Examples of the benzophenone-based ultraviolet absorbers include 2,4-dihydroxybenzophenone, 2-hydroxy-4-acetoxybenzopheone, 2-hydroxy-4-methoxy benzophenone, 2,2′-di-hydroxy-4-metoxybenzopheone, 2,2′-di-hydroxy-4,4′-metoxybenzophenone, 2-hydroxy-4-n-octoxybenzophenone, 2-hydroxy-4-dodecyloxy benzophenone, and 2-hydroxy-4-(2-hydroxy-3-methacryloxy)propoxybenzophenone. Examples of the benzotriazole-based ultraviolet absorbers include 2(2′-hydroxy-3′-tert-butyl-5′-methylphenyl)-5-chlorobenzo triazole, 2(2′-hydroxy-5′-tert-butylphenyl)benzotriazole, 2(2′-hydroxy-3′,5′-di-tert-amylphenyl)benzotriazole, 2(2′-hydroxy-3′,5′-di-tert-butylphenyl)-5-chlorobenzotriazole, and 2(2′-hydroxy-5′-tert-octylphenyl)benzotriazole. Examples of the salicylic acid ester-based absorbers include phenyl salicylate, p-octylphenyl salicylate, and p-tert-butyl phenyl salicylate. Particularly preferred among these exemplified ultraviolet absorbers are 2-hydroxy-4-methoxybenzophenone, 2,2′-di-hydroxy-4,4′-methoxy benzophenone, 2(2′-hydroxy-3′-tert-butyl-5′-methyl phenyl)-5-chlorobenzotriazole, 2(2′-hydroxy-5′-tert-butylphenyl)benzotriazole, 2(2′-hydroxy-3′,5′-di-tert-amylphenyl)benzotriazole, and 2(2′-hydroxy-3′,5′-di-tert-butyphenyl)-5-chlorobenzotriazole.

A plurality of ultraviolet absorbers having different absorption wavelengths are preferably used to obtain a high barrier effect within a wide wavelength range. As the ultraviolet absorber for liquid crystal there is preferably used one having an excellent absorption of ultraviolet rays having a wavelength of 370 nm or less from the standpoint of prevention of deterioration of liquid crystal or one having little absorption of visible light having a wavelength of 400 nm or more. Particularly preferred examples of the ultraviolet absorbers include benzotriazole-based compounds and salicylic acid ester-based compounds previously exemplified. Preferred among these ultraviolet absorbers are benzotriazole-based compounds because they cause little unnecessary coloration of cellulose ester.

As the ultraviolet absorbers there may be used also compounds disclosed in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, and JP-A-2000-204173.

The amount of the ultraviolet absorbers to be incorporated is preferably from 0.001 to 5% by mass, more preferably from 0.01 to 1% by mass based on the cellulose acylate. The amount of the ultraviolet absorbers to be incorporated is preferably 0.001% by mass or more because the desired effect of these ultraviolet absorbers can be sufficiently exerted. On the contrary, the amount of the ultraviolet absorbers to be incorporated is preferably 5% by mass or less because the ultraviolet absorbers can be prevented from bleeding out to the surface of the film.

Further, the ultraviolet absorber may be added at the same time as the dissolution of cellulose acylate or may be added to the dope prepared by dissolution. It is particularly preferred that using a static mixer, an ultraviolet absorber be added to the dope which is ready to be casted because the spectral absorption characteristics can be easily adjusted.

### <Deterioration Inhibitor>

The aforementioned deterioration inhibitor can be used to prevent the deterioration or decomposition of cellulose triacetate, etc. Examples of the deterioration inhibitor include compounds such as butylamine, hindered amine compound (JP-A-8-325537), guanidine compound (JP-A-5-271471), benzotriazole-based ultraviolet absorber (JP-A-6-235819) and benzophenone-based ultraviolet absorber (JP-A-6-118233).

### <Peel Accelerator>

Examples of the peel accelerator include citric acid ethylesters. For the details of the infrared absorbers, reference can be made to JP-A-2001-194522.

These additives may be added at any time during the process of preparing the dope. The step of adding these additives may be conducted at the final step in the process of preparing the dope. Further, the amount of these materials to be added is not specifically limited so far as their functions can be exhibited. In the case where the cellulose acylate film is in a multi-layer form, the kind and added amount of additives in the various layers may be different. As disclosed in JP-A-2001-151902 for example, these techniques have heretofore been known. The glass transition point Tg of the cellulose acylate film measured by a Type DVA-225 Vibron dynamic viscoelasticity meter (produced by IT Keisoku Seigyo Co., Ltd.) and the elastic modulus of the cellulose acylate measured by a Type Strograph R2 tensile testing machine (produced by TOYO SEIKI KOGYO CO., LTD.) are preferably predetermined to a range of from 70 to 150° C., more preferably from 80 to 135° C., and a range of from 1,500 to 4,000 MPa, more preferably from 1,500 to 3,000 MPa, respectively, by properly selecting the kind and added amount of these additives. In other words, the cellulose acylate film of the invention preferably exhibits a glass transition point Tg and an elastic modulus falling within the above defined range from the standpoint of adaptability to the step of forming polarizing plate or assembling liquid crystal display device.

As these additives there may be properly used those disclosed in detail in Kokai Giho No. 2001-1745, Mar. 15, 2001, pp. 16 and after, Japan Institute of Invention and Innovation.

### <Particulate Matting Agent>

The cellulose acylate film of the invention preferably has a particulate material incorporated therein as a matting agent. Examples of the particulate material employable herein include silicon dioxide, titanium dioxide, aluminum oxide, zirconium oxide, calcium carbonate, talc, clay, calcined kaolin, calcined calcium silicate, hydrous calcium silicate, aluminum silicate, magnesium silicate, and calcium phosphate. The particulate material preferably contains silicon to reduce turbidity. In particular, silicon dioxide is preferred. The particulate silicon dioxide preferably has a primary average particle diameter of 20 nm or less and an apparent specific gravity of 70 g/l or more. The primary average particle diameter of the particulate silicon dioxide is more preferably as small as from 5 to 16 nm to reduce the haze of the film. The apparent specific gravity of the particulate silicon dioxide is preferably not smaller than from 90 to 200 g/l, more preferably not smaller than from 100 to 200 g/l. As the apparent specific gravity of the silicon dioxide rises, a high concentration dispersion can be prepared more easily to reduce haze and agglomeration.

The amount of the aforementioned particulate silicon dioxide, if used, is preferably from 0.01 to 0.3 parts by mass based on 100 parts by mass of the polymer component containing cellulose acylate.

These particles normally form secondary particles having an average particle diameter of from 0.1 to 3.0 μm. These particles are present in the film in the form of agglomerates of primary particles to form an uneveness having a height of from 0.1 to 3.0 μm on the surface of the film. The secondary average particle diameter is preferably from not smaller than 0.2 μm to not greater than 1.5 μm, more preferably from not smaller than 0.4 μm to not greater than 1.2 μm, most preferably from not smaller than 0.6 μm to not greater than 1.1 μm, When the secondary average particle diameter exceeds 1.5 μm, the resulting film exhibits a raised haze. On the contrary, when the secondary average particle diameter falls below 0.2 μm, the effect of preventing squeak is reduced.

For the determination of primary and secondary particle diameter, particles in the film are observed under scanning electron microphotograph. The particle diameter is defined by the diameter of the circle circumscribing the particle. 200 particles which are located in dispersed positions are observed. The measurements are averaged to determine the average particle diameter.

As the particulate silicon dioxide there may be used a conunercially available product such as Aerosil R972, R972V, R974, R812, 200, 200V, 300, R202, OX50 and TT600 (produced by Nippon Aerosil Co., Ltd.). The particulate zirconium oxide is commercially available as Aerosil R976 and R811 (produced by Nippon Aerosil Co., Ltd.). These products can be used in the invention.

Particularly preferred among these products are Aerosil 200V and Aerosil R972V because they are a particulate silicon dioxide having a primary average particle diameter of 20 nm or less and an apparent specific gravity of 70 g/l or more that exerts a great effect of reducing friction coefficient while keeping the turbidity of the optical film low.

In the invention, in order to obtain a cellulose acylate film containing particles having a small secondary average particle diameter, various methods may be proposed to prepare a dispersion of particles. For example, a method may be employed which comprises previously preparing a particulate dispersion of particles in a solvent, stirring the particulate dispersion with a small amount of a cellulose acylate solution which has been separately prepared to make a solution, and then mixing the solution with a main cellulose acylate dope solution. This preparation method is desirable because the particulate silicon dioxide can be fairly dispersed and thus can be difficulty re-agglomerated. Besides this method, a method may be employed which comprises stirring a solution with a small amount of cellulose ester to make a solution, dispersing the solution with a particulate material using a dispersing machine to make a solution having particles incorporated therein, and then thoroughly mixing the solution having particles incorporated therein with a dope solution using an in-line mixer. The invention is not limited to these methods. The concentration of silicon dioxide during the mixing and dispersion of the particulate silicon dioxide with a solvent or the like is preferably from 5 to 30% by mass, more preferably from 10 to 25% by mass, most preferably from 15 to 20% by mass. As the concentration of dispersion rises, the turbidity of the solution with respect to the added amount decreases to further reduce haze and agglomeration to advantage. The content of the matting agent in the final cellulose acylate dope solution is preferably from 0.01 to 1.0 g, more preferably from 0.03 to 0.3 g, most preferably from 0.08 to 0.16 g per m².

Preferred examples of the solvent which is a lower alcohol include methyl alcohol, ethyl alcohol, propyl alcohol, isopropyl alcohol, and butyl alcohol. The solvent other than lower alcohol is not specifically limited, but solvents which are used during the preparation of cellulose ester are preferably used.

The aforementioned organic solvent in which the cellulose acylate of the invention is dissolved will be described hereinafter.

In the invention, as the organic solvent there may be used either a chlorine-based solvent mainly composed of chlorine-based organic solvent or a nonchlorine-based solvent free of chlorine-based organic solvent.

### <Chlorine-Based Solvent>

In order to prepare the cellulose acylate solution of the invention, as the main solvent there is preferably used a chlorine-based organic solvent. In the invention, the kind of the chlorine-based organic solvent is not specifically limited so far as the cellulose acylate can be dissolved and casted to form a film, thereby attaining its aim. The chlorine-based organic solvent is preferably dichloromethane or chloroform. In particular, dichloromethane is preferred. The chlorine-based organic solvent may be used in admixture with organic solvents other than chlorine-based organic solvent. In this case, it is necessary that dichloromethane be used in an amount of at least 50% by mass based on the total amount of the organic solvents. Other organic solvents to be used in combination with the chlorine-based organic solvent in the invention will be described hereinafter. In some detail, other organic solvents employable herein are preferably selected from the group consisting of ester, ketone, ether, alcohol and hydrocarbon having from 3 to 12 carbon atoms. The ester, ketone, ether and alcohol may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group at the same time. The number of carbon atoms in the solvent having two or more functional groups, if used, may fall within the range defined for the compound having any of these functional groups. Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The alcohol to be used in combination with the chlorine-based organic solvent may be preferably straight-chain, branched or cyclic. Preferred among these organic solvents is saturated aliphatic hydrocarbon. The hydroxyl group in the alcohol may be primary to tertiary. Examples of the alcohol employable herein include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol. Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene.

Examples of the combination of chlorine-based organic solvent and other organic solvents include the following formulations, but the invention is not limited thereto.

Dichloromethane/methanol/ethanol/butanol (80/10/5/5, parts by mass)

Dichloromethane/acetone/methanol/propanol (80/10/5/5, parts by mass)

Dichloromethane/methanol/butanol/cyclohexane (80/10/5/5, parts by mass)

Dichloromethane/methyl ethyl ketone/methanol/butanol (80/10/5/5, parts by mass)

Dichloromethane/acetone/methyl ethyl ketone/ethanol/isopropanol (68/10/10/5/7, parts by mass)

Dichloromethane/cyclopentanone/methanol/isopropanol (77/10/5/8, parts by lass)

Dichloromethane/methyl acetate/butanol (80/10/10, parts by mass)

Dichloromethane/cyclohexanone/methanol/hexane (70/20/5/5, parts by mass)

Dichloromethane/methyl ethyl ketone/acetone/methanol/ethanol (50/20/20/5/5, parts by mass)

Dichloromethane/1,3-dioxolane/methanol/ethanol (70/20/5/5, parts by mass)

Dichloromethane/dioxane/acetone/methanol/ethanol (60/20/10/5/5, parts by mass)

Dichloromethane/acetone/cyclopentanone/ethanol/isobutanol/cyclohexane (65/10/10/5/5/5, parts by mass)

Dichloromethane/methyl ethyl ketone/acetone/methanol/ethanol (70/10/10/5/5, parts by mass)

Dichloromethane/acetone/ethyl acetate/ethanol/butanol/hexane (65/10/10/5/5/5, parts by mass)

Dichloromethane/methyl acetoacetate/methanol/ethanol (65/20/10/5, parts by mass)

Dichloromethane/cyclopentanone/ethanol/butanol (65/20/10/5, parts by mass)

### <Nonchlorine-Based Solvent>

The nonchlorine-based solvent which can be preferably used to prepare the cellulose acylate solution of the invention will be described hereinafter. The nonchlorine-based organic solvent to be used in the invention is not specifically limited so far as the cellulose acylate can be dissolved and casted to form a film, thereby attaining its aim. The nonchlorine-based organic solvent employable herein is preferably selected from the group consisting of ester, ketone, ether and having from 3 to 12 carbon atoms. The ester, ketone and ether may have a cyclic structure. A compound having two or more of functional groups (i.e., —O—, —CO—, and —COO—) of ester, ketone and ether, too, may be used as a solvent. The solvent may have other functional groups such as alcohol-based hydroxyl group. The number of carbon atoms in the solvent having two or more functional groups, if used, may fall within the range defined for the compound having any of these functional groups, Examples of C₃-C₁₂ esters include ethyl formate, propyl formate, pentyl formate, methyl acetate, ethyl acetate, and pentyl acetate. Examples of C₃-C₁₂ ketones include acetone, methyl ethyl ketone, diethyl ketone, diisobutyl ketone, cyclopentanone, cyclohexanone, and methyl cyclohexanone. Examples of C₃-C₁₂ ethers include diisopropyl ether, dimethoxymethane, dimethoxyethane, 1,4-dioxane, 1,3-dioxolane, tetrahydrofurane, anisole, and phenethol. Examples of the organic solvent having two or more functional groups include 2-ethoxyethyl acetate, 2-methoxyethanol, and 2-butoxyethanol.

The nonchlorine-based organic solvent to be used for cellulose acylate may be selected from the aforementioned various standpoints of view but is preferably as follows. In some detail, the nonchlorine-based solvent is preferably a mixed solvent mainly composed of the aforementioned nonchlorine-based organic solvent. This is a mixture of three or more different solvents wherein the first solvent is at least one or a mixture of methyl acetate, ethyl acetate, methyl formate, ethyl formate, acetone, dioxolane and dioxane, the second solvent is selected from the group consisting of ketones or acetoacetic acid esters having from 4 to 7 carbon atoms and the third solvent is selected from the group consisting of alcohols or hydrocarbons having from 1 to 10 carbon atoms, preferably alcohols having from 1 to 8 carbon atoms. In the case where the first solvent is a mixture of two or more solvents, the second solvent may be omitted. The first solvent is more preferably methyl acetate, acetone, methyl formate, ethyl formate or mixture thereof. The second solvent is preferably methyl ethyl ketone, cyclopentanone, cyclohexanone, methyl acetylacetate or mixture thereof.

The third solvent which is an alcohol may be straight-chain, branched or cyclic. Preferred among these alcohols are unsaturated aliphatic hydrocarbons. The hydroxyl group in the alcohol may be primary to tertiary. Examples of the alcohol include methanol, ethanol, 1-propanol, 2-propanol, 1-butanol, 2-butanol, t-butanol, 1-pentanol, 2-methyl-2-butanol, and cyclohexanol. As the alcohol there may be used also a fluorine-based alcohol. Examples of the fluorine-based alcohol include 2-fluoroethanol, 2,2,2-trifluoroethanol, and 2,2,3,3-tetrafluoro-1-propanol. Further, the hydrocarbon may be straight-chain, branched or cyclic. Either an aromatic hydrocarbon or aliphatic hydrocarbon may be used. The aliphatic hydrocarbon may be saturated or unsaturated. Examples of the hydrocarbon include cyclohexane, hexane, benzene, toluene, and xylene. The alcohols and hydrocarbons which are third solvents may be used singly or in admixture of two or more thereof without any limitation. Specific examples of the alcohol which is a third solvent include methanol, ethanol, 1-propanol, 2-propanol, 1-butanol, 2-butanol, cyclohexanol, cyclohexane, and hexane. Particularly preferred among these alcohols are methanol, ethanol, 1-propanol, 2-propanol, and 1-butanol.

Referring to the mixing ratio of the aforementioned three solvents, the mixing ratio of the first solvent, the second solvent and the third solvent are preferably from 20 to 95% by mass, from 2 to 60% by mass and from 2 to 30% by mass, more preferably from 30 to 90% by mass, from 3 to 50% by mass and from 3 to 25% by mass, particularly from 30 to 90% by mass, from 3 to 30% by mass and from 3 to 15% by mass, respectively, based on the total mass of the mixture. For the details of the nonchlorine-based organic solvents to be used in the invention, reference can be made to Kokai Giho No. 2001-1745, Mar. 15, 2001, pp. 12-16, Japan Institute of Invention and Innovation. Examples of the combination of nonchlorine-based organic solvents include the following formulations, but the invention is not limited thereto.

Methyl acetate/acetone/methanol/ethanol/butanol (75/10/5/5/5, parts by mass)

Methyl acetate/acetone/methanol/ethanol/propanol (75/10/5/5/5, parts by mass)

Methyl acetate/acetone/methanol/butanol/cyclohexane (75/10/5/5/5, parts by mass)

Methyl acetate/acetone/ethanol/butanol (81/8/7/4, parts by mass)

Methyl acetate/acetone/ethanol/butanol (82/10/4/4, parts by mass)

Methyl acetate/acetone/ethanol/butanol (80/10/4/6, parts by mass)

Methyl acetate/methyl ethyl ketone/methanol/butanol (80/10/5/5, parts by mass)

Methyl acetate/acetone/methyl ethyl ketone/ethanol/isopropanol (68/10/10/5/7, parts by mass)

Methyl acetate/cyclopentanone/methanol/isopropanol (77/10/5/8, parts by mass)

Methyl acetate/acetone/butanol (90/5/5, parts by mass)

Methyl acetate/cyclopentanone/acetone/methanol/butanol (60/15/15/5/5, parts by mass)

Methyl acetate/cyclohexanone/methanol/hexane (70/20/5/5, parts by mass)

Methyl acetate/methyl ethyl ketone/acetone/methanol/ethanol (50/20/20/5/5, parts by mass)

Methyl acetate/1,3-dioxolane/methanol/ethanol (70/20/5/5, parts by mass)

Methyl acetate/dioxane/acetone/methanol/ethanol (60/20/10/5/5, parts by mass)

Methyl acetate/acetone/cyclopentanone/ethanol/isobutanol/cyclohexane (65/10/10/5/5/5, parts by mass)

Methyl formate/methyl ethyl ketone/acetone/methanol/ethanol (50/20/20/5/5, parts by mass)

Methyl formate/acetone/ethyl acetate/ethanol/butanol/hexane (65/10/10/5/5/5, parts by mass)

Acetone/methyl acetoacetate/methanol/ethanol (65/20/10/5, parts by mass)

Acetone/cyclopentanone/methanol/butanol (65/20/10/5, parts by mass)

Acetone/1,3-dioxolane/ethanol/butanol (65/20/10/5, parts by mass)

1,3-Dioxolane/cyclohexanone/methyl ethyl ketone/methanol/butanol (60/20/10/5/5, parts by mass)

Further, cellulose acylate solutions prepared by the following methods may be used.

Method which comprises preparing a cellulose acylate solution with methyl acetate/acetone/ethanol/butanol (81/8/7/4, parts by mass), filtering and concentrating the solution, and then adding 2 parts by mass of butanol to the solution

Method which comprises preparing a cellulose acylate solution with methyl acetate/acetone/ethanol/butanol (84/10/4/2, parts by mass), filtering and concentrating the solution, and then adding 4 parts by mass of butanol to the solution

Method which comprises preparing a cellulose acylate solution with methyl acetate/acetone/ethanol (84/10/6, parts by mass), filtering and concentrating the solution, and then adding 5 parts by mass of butanol to the solution

The dope to be used in the invention comprises dichloromethane incorporated therein in an amount of 10% by mass or less based on the total mass of the organic solvents of the invention besides the aforementioned nonchlorine-based organic solvent of the invention.

### <Properties of Cellulose Acylate Solution>

The cellulose acylate solution of the invention preferably comprises cellulose acylate incorporated in the aforementioned organic solvent in an amount of from 10 to 30% by mass, more preferably from 13 to 27% by mass, particularly from 15 to 25% by mass from the standpoint of adaptability to film casting. The adjustment of the concentration of the cellulose acylate solution to the predetermined range may be effected at the dissolution step. Alternatively, a cellulose acylate solution which has been previously prepared in a low concentration (e.g., 9 to 14% by mass) may be adjusted to the predetermined concentration range at a concentrating step described later. Alternatively, a cellulose acylate solution which has been previously prepared in a high concentration may be adjusted to the predetermined lower concentration range by adding various additives thereto. Any of these methods may be used so far as the predetermined concentration range can be attained.

In the invention, the molecular mass of the associated cellulose acylate in the cellulose acylate solution which has been diluted with an organic solvent having the same formulation to a concentration of from 0.1 to 5% by mass is preferably from 150,000 to 15,000,000, more preferably from 180,000 to 9,000,000 from the standpoint of solubility in solvent. For the determination of the molecular mass of associated product, a static light scattering method may be used. The dissolution is preferably effected such that the concurrently determined square radius of inertia ranges from 10 to 200 inn, more preferably from 20 to 200 nm. Further, the dissolution is preferably effected such that the second virial coefficient ranges from −2×10⁻⁴ to +4×10⁻⁴, more preferably from −2×10⁻⁴ to +2×10⁻⁴.

The definition of the molecular mass of the associated product, the square radius of inertia and the second virial coefficient will be described hereinafter. These properties are measured by static light scattering method in the following manner. The measurement is made within a dilute range for the convenience of device, but these measurements reflect the behavior of the dope within the high concentration range of the invention.

Firstly, the cellulose acylate is dissolved in the same solvent as used for dope to prepare solutions having a concentration of 0.1% by mass, 0.2% by mass, 0.3% by mass and 0.4% by mass, respectively. The cellulose acylate to be weighed is dried at 120° C. for 2 hours before use to prevent moistening. The cellulose acylate thus dried is then weighed at 25° C. and 10% RH. The dissolution of the cellulose acylate is effected according to the same method as used in the dope dissolution (ordinary temperature dissolution method, cooled dissolution method, high temperature dissolution method). Subsequently, these solutions with solvent are filtered through a Teflon filter having a pore diameter of 0.2 μm. The solutions thus filtered are each then measured for static light scattering every 10 degrees from 30 degrees to 140 degrees at 25° C. using a Type DLS-700 light scattering device (produced by Otsuka Electronics Co., Ltd.). The data thus obtained are then analyzed by Berry plotting method. For the determination of refractive index required for this analysis, the refractive index of the solvent is measured by an Abbe refractometer. For the determination of concentration gradient of refractive index (dn/dc), the same solvent and solution as used in the measurement of light scattering are measured using a type DRM-1021 different refractometer (produced by Otsuka Electronics Co., Ltd.).

### (Preparation of Dope)

The preparation of the cellulose acylate solution (dope) will be described hereinafter. The method of dissolving the cellulose acylate is not specifically limited. The dissolution of the cellulose acylate may be effected at room temperature. Alternatively, a cooled dissolution method or a high temperature dissolution method may be used. Alternatively, these dissolution methods may be in combination. For the details of the method of preparing a cellulose acylate solution, reference can be made to JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017, and JP-A-11-302388. The aforementioned method of dissolving cellulose acylate in an organic solvent may be applied also to the invention so far as it falls within the scope of the invention. For the details of these methods, reference can be made to Kokai Giho No. 2001-1745, Mar. 15, 2001, pp. 22-25, Japan Institute of Invention and Innovation. The cellulose acylate dope solution of the invention is then subjected to concentration and filtration. For the details of these methods, reference can be made similarly to Kokai Giho No. 2001-1745, Mar. 15, 2001, page 25, Japan Institute of Invention and Innovation. In the case where dissolution is effected at high temperatures, the temperature is higher than the boiling point of the organic solvent used in most cases. In this case, dissolution is effected under pressure.

The viscosity and dynamic storage elastic modulus of the cellulose acylate solution preferably fall within the following range from the standpoint of castability. 1 mL of the sample solution is measured using a Type CLS 500 rheometer (produced by TA Instruments) with a steel cone having a diameter of 4 cm/2° (produced by TA Instruments). Referring to the measurement conditions, measurement is effected every 2° C. per minute within a range of from −10° C. to 40° C. at an oscillation step with temperature ramp to determine 40° C. static non-Newton viscosity n*(Pa·s) and −5° C. storage elastic modulus G′(Pa). The sample solution is previously kept at the measurement starting temperature before measurement. In the invention, the sample solution preferably has a 40° C. viscosity of from 1 to 400 Pa·s, more preferably from 10 to 200 Pa·s, and a 15° C. dynamic storage elastic modulus of 500 Pa or more, more preferably from 100 to 1,000,000 Pa. The low temperature dynamic storage elastic modulus of the sample solution is preferably as great as possible, For example, if the casting support has a temperature of −5° C., the dynamic storage elastic modulus of the sample solution is preferably from 10,000 to 1,000,000 Pa at −5° C. If the casting support has a temperature of −50° C., the dynamic storage elastic modulus of the sample solution is preferably from 10,000 to 5,000,000 Pa at −50° C.

In the invention, in the case where a high concentration dope is obtained, a high concentration cellulose acylate solution having an excellent stability can be obtained without relying on the concentrating method. In order to further facilitate dissolution, the cellulose acylate may be dissolved in a low concentration. The solution thus prepared is then concentrated by a concentrating method. The concentrating method is not specifically limited. For example, a method may be used which comprises introducing a low concentration solution into the gap between a case body and the rotary orbit of the periphery of a rotary blade that rotates circumferentially inside the case body while giving a temperature difference between the solution and the case body to vaporize the solution, thereby obtaining a high concentration solution (see, e.g., JP-A-4-259511). Alternatively, a method may be used which comprises blowing a heated low concentration solution into a vessel through a nozzle so that the solvent is flash-evaporated over the distance from the nozzle to the inner wall of the vessel while withdrawing the solvent thus evaporated from the vessel and the resulting high concentration solution from the bottom of the vessel (see, e.g., U.S. Pat. No. 2,541,012, U.S. Pat. No. 2,858,229, U.S. Pat. No. 4,414,341, U.S. Pat. No. 4,504,355).

Prior to casting, the solution is preferably freed of foreign matters such as undissolved matter, dust and impurities by filtration through a proper filtering material such as metal gauze and flannel. For the filtration of the cellulose acylate solution, a filter having an absolute filtration precision of from 0.1 to 100 μm is preferably used. More preferably, a filter having an absolute filtration precision of from 0.5 to 25 μm is used. The thickness of the filter is preferably from 0.1 to 10 mm, more preferably from 0.2 to 2 mm. In this case, filtration is preferably effected under a pressure of 1.6 MPa or less, more preferably 1.2 MPa or less, even more preferably 1.0 MPa or less, particularly 0.2 MPa or less. As the filtering material there is preferably used any known material such as glass fiber, cellulose fiber, filter paper and fluororesin, e.g., ethylene tetrafluoride resin. In particular, ceramics, metal, etc. are preferably used. The viscosity of the cellulose acylate solution shortly before filming may be arbitrary so far as the cellulose acylate solution can be casted during filming and normally is preferably from 10 Pa·s to 2,000 Pa·s, more preferably from 30 Pa·s to 1,000 Pa·s, even more preferably from 40 Pa·s to 500 Pa·s. The temperature of the cellulose acylate solution shortly before filming is not specifically limited so far as it is the casting temperature but is preferably from −5° C. to +70° C., more preferably from −5° C. to +55° C.

### <Filming>

The cellulose acylate film of the invention can be obtained by filming the aforementioned cellulose acylate solution. As the filming method and the filming device there may be used any solution casting/filing method and solution casting/filming device for use in the related art method of producing cellulose acylate film, respectively.

An ordinary production method using the aforementioned device will be described hereinafter. The dope (cellulose acylate solution) prepared in the dissolving machine (kiln) is stored in a storage kiln so that bubbles contained in the dope are removed to make final adjustment. The dope thus adjusted is then delivered from the dope discharge port to a pressure die through a pressure constant rate gear pump capable of delivering a liquid at a constant rate with a high precision depending on the rotary speed. The dope is then uniformly casted through the slit of the pressure die over a metallic support in the casting portion which is being running endlessly. When the metallic support has made substantially one turn, the half-dried dope film (also referred to as “web”) is then peeled off the metallic support. The web thus obtained is then dried while being conveyed by a tenter with the both ends thereof being clamped by a clip to keep its width. Subsequently, the web is conveyed by a group of rolls in the drying apparatus to finish drying. The web is then wound to a predetermined length by a winding machine. The combination of tenter and a group of rolls varies with the purpose. In a solution casting/filming method for use in functional protective layer for electronic display, a coating device is often added to the solution casting/filming device for the purpose of surface working of film such as subbing layer, antistatic layer, anti-halation layer and protective layer. The various producing steps will be briefly described hereinafter, but the invention is not limited thereto.

Firstly, in order to prepare a cellulose acylate film by a solvent casting method, the cellulose acylate solution (dope) thus prepared is casted over a drum or band so that the solvent is evaporated to form a film. The dope to be casted is preferably adjusted in its concentration such that the solid content is from 5 to 40% by mass. It is preferred that the surface of the drum or band be previously mirror-like finished. The dope is preferably casted over a drum or band having a surface temperature of 30° C. or less, particularly over a metallic support having a temperature of from −10 to 20° C. Further, methods disclosed in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511, and JP-A-02-208650 may be used in the invention.

### <Casting>

Examples of the solution casting method include a method which comprises uniformly extruding a dope prepared onto a metallic support through a pressure die, a doctor blade method which comprises adjusting the thickness of a dope casted over a metallic support using a blade, and a reverse roll coater method which comprises adjusting the thickness of the dope casted using a roll that rotates in the reverse direction. Preferred among these casting methods is the pressure die method. Examples of the pressure die include coat hunger type pressure die, and T-die type pressure die. Any of these pressure dies may be preferably used. Besides the aforementioned methods, various conventional methods for casting/filming a cellulose triacetate solution may be effected. By predetermining the various conditions taking into account the difference in boiling point between solvents used, the same effects as the contents disclosed in the above cited references can be exerted. As the endless running metallic support to be used in the production of the cellulose acylate film of the invention there may be used a drum which has been mirror-like finished by chromium plating or a stainless steel belt (also referred to as “band”) which has been mirror-like finished by polishing. One or more pressure dies for producing the cellulose acylate film of the invention may be disposed above the metallic support. Preferably, the number of pressure dies is 1 or 2. In the case where two or more pressure dies are provided, the dope to be casted may be allotted to these dies at various ratios. A plurality of precision constant rate gear pumps may be used to deliver the dope to these dies at the respect ratio. The temperature of the cellulose acylate solution to be casted is preferably from −10 to 55° C., more preferably from 25 to 50° C. In this case, the temperature of the cellulose acylate solution may be the same at all the steps or may differ from step to step. In the latter case, it suffices if the temperature of the cellulose acylate solution is the desired temperature shortly before being casted.

### <Multi-Layer Casting>

The cellulose acylate solution may be casted over a smooth band or drum as a metallic support in the form of a single layer. Alternatively, two or more cellulose acylate solutions may be casted over the metallic support. In the case where a plurality of cellulose acylate solutions are casted, a cellulose acylate-containing solution may be casted over the metallic support through a plurality of casting ports disposed at an interval along the direction of running of the metallic support to make lamination. For example, any method as disclosed in JP-A-61-158414, JP-A-1-122419, and JP-A-11-198285 may be employed.

Alternatively, a cellulose acylate solution may be casted through two casting ports to make filming. For example, any method as disclosed in JP-B-60-27562, JP-A-61-94724, JP-A-61-947245, JP-A-61-104813, JP-A-61-158413, and JP-A-6-134933 may be employed. As disclosed in JP-A-56-162617, a cellulose acylate film casting method may be used which comprises simultaneously casting a high viscosity cellulose acylate solution and a low viscosity cellulose acylate solution with a flow of the high viscosity cellulose acylate solution surrounded by the low viscosity cellulose acylate solution. Further, as disclosed in JP-A-61-94724 and JP-A-61-94725, it is a preferred embodiment that the outer solution contains a greater content of an alcohol component as a poor solvent than the inner solution. Alternatively, two casting ports may be used so that the film formed on the metallic support by the first casting port is peeled off the metallic support and the second casting is then made on the side of the film which has come in contact with the metallic support. For example, a method disclosed in JP-B-44-20235 may be used. The cellulose acylate solutions to be casted may be the same or different and thus are not specifically limited. In order to render a plurality of cellulose acylate layers functional, cellulose acylate solutions having a formulation according to the function may be extruded through the respective casting port. The casting of the cellulose acylate solution may be accompanied by the casting of other functional layers (e.g., adhesive layer, dye layer, antistatic layer, anti-halation layer, ultraviolet-absorbing layer, polarizing layer).

In order to form a film having a desired thickness from the related art single layer solution, it is necessary that a cellulose acylate solution having a high concentration and a high viscosity be extruded. In this case, a problem often arises that the cellulose acylate solution exhibits a poor stability and thus forms a solid material that causes the generation of granular structure or poor planarity. In order to solve these problems, a plurality of cellulose acylate solutions can be casted through casting ports, making it possible to extrude high viscosity solutions onto the metallic support at the same time, Iii this manner, a film having an improved planarity and hence excellent surface conditions can be prepared. Further, the use of a highly concentrated cellulose acylate solution makes it possible to attain the reduction of the drying load that can enhance the production speed of film.

In the case of co-casting method, the thickness of the inner solution and the outer solution are not specifically limited, but the thickness of the outer solution is preferably from 1 to 50%, more preferably from 2 to 30% of the total thickness. In the case of co-casting of three of more layers, the sum of the thickness of the layer in contact with the metallic support and the layer in contact with air is defined as the thickness of the outer layer. In the case of co-casting, cellulose acylate solutions having different concentrations of the aforementioned additives such as plasticizer, ultraviolet absorber and matting agent can be co-casted to a cellulose acylate film having a laminated structure. For example, a cellulose acylate film having a skin layer/core layer/skin layer structure can be prepared. For example, the matting agent can be incorporated much or only in the skin layer. The plasticizer and ultraviolet absorber may be incorporated more in the core layer than in the skin layer or only in the core layer. The kind of the plasticizer and the ultraviolet absorber may differ from the core layer to the skin layer. For example, at least either of low volatility plasticizer and ultraviolet absorber may be incorporated in the skin layer while a plasticizer having an excellent plasticity or an ultraviolet absorber having excellent ultraviolet absorbing properties may be incorporated in the core layer. In another preferred embodiment, a peel accelerator may be incorporated in only the skin layer on the metallic support side. It is also preferred that the skin layer contain an alcohol as a poor solvent more than the core layer in order that the solution might be gelled by cooling the metallic support by a cooled drum method. The skin layer and the core layer may have different Tg values. It is preferred that Tg of the core layer be lower than that of the skin layer. Further, the viscosity of the solution containing cellulose acylate may differ from the skin layer to the core layer during casting. It is preferred that the viscosity of the skin layer be lower than that of the core layer. However, the viscosity of the core layer may be lower than that of the skin layer.

### <Stretching>

The cellulose acylate film of the invention may be subjected to stretching to adjust the retardation thereof. Further, the cellulose acylate film may be positively subjected to crosswise stretching. For the details of these stretching methods, reference can be made to JP-A-62-115035, JP-A-4-152125, JP-A-4-284211, JP-A-4-298310, and JP-A-11-48271. In accordance with these methods, the cellulose acylate film produced is stretched to raise the in-plane retardation value thereof.

The stretching of the film is effected at ordinary temperature or under heating. The heating temperature is preferably not higher than the glass transition temperature of the film. The film may be subjected to monoaxial stretching only in the longitudinal or crosswise direction or may be subjected to simultaneous or successive biaxial stretching.

As previously mentioned, a cellulose acylate film the degree of orientation of which has been raised by stretching or the like normally shows a raised change of optical compensation properties with atmospheric humidity. Accordingly, the cellulose acylate film according to the invention is preferably stretched at a lower draw ratio than ordinary value, more preferably from 1.01 to 1.3, even more preferably from 1.01 to 1.1, still more preferably from 1.01 to 1.05.

The stretching may be effected in the course of filming step. Alternatively, the raw fabric of film wound may be subjected to stretching. In the former case, the film may be stretched while retaining residual solvent therein. When the content of residual solvent is from 2 to 30%, stretching can be fairly effected.

### <Drying>

General examples of the method of drying the dope on the metallic support in the production of the cellulose acylate film include a method which comprises blowing a hot air against the web on the front surface of the metallic support (drum or band), that is, the front surface of the web on the metallic support or on the back surface of the drum or band, and a liquid heat conduction method which comprises allowing a temperature-controlled liquid to come in contact with the back surface of the belt or drum, which is the side thereof opposite the dope casting surface, so that heat is conducted to the drum or belt to control the surface temperature. Preferred among these drying methods is the back surface liquid heat conduction method. The surface temperature of the metallic support before casting may be arbitrary so far as it is not higher than the boiling point of the solvent used in the dope. However, in order to accelerate drying or eliminate fluidity on the metallic support, it is preferred that the surface temperature of the metallic support be predetermined to be from 1 to 10° C. lower than the boiling point of the solvent having the lowest boiling point among the solvents used. However, this limitation is not necessarily applied in the case where the casted dope is cooled and peeled off the metallic support without being dried.

In the invention, the thickness of the finished (dried) cellulose acylate film depends on the purpose but is normally from 5 μm to 500 μm, preferably from 20 μm to 300 μm, particularly preferably from 40 μin to 110 μm for VA mode liquid crystal display devices. On the other hand, when the thickness of the film is from 110 μm to 180 μm, the drying burden during casting rises. However, since the magnitude of optical properties is proportional to the thickness of the film, the desired optical properties can be attained by increasing the thickness of the film. Further, since the moisture permeability of the film decreases inversely proportional to the thickness of the film, the film can be provided with a reduced moisture permeability and thus is less permeable to water by raising the thickness of the film. Thus, the cellulose acylate film is advantageous in, e.g., polarizing plate durability test at 60° C.-90% RH for 500 hours. Comprehensively considering, the thickness of the cellulose acylate film is particularly preferably from 40 Ξm to 1,800 μm.

In order to adjust the thickness of the film to the desired value, the concentration of solid content in the dope, the gap of slit of the die, the extrusion pressure of die, the speed of metallic support, etc. may be properly adjusted. The width of the cellulose acylate film thus obtained is preferably from 0.5 to 3 m, more preferably from 0.6 to 2.5 m, even more preferably from 0.8 to 2.2 m. The winding length of the film per roll is preferably from 100 to 10,000 m, more preferably 500 to 7,000 m, even more preferably from 1,000 to 6,000 m. During winding, the film is preferably knurled at least at one edge thereof. The width of the knurl is preferably from 3 mm to 50 mm, more preferably from 5 mm to 30 mm. The height of the knurl is preferably from 0.5 to 500 μm, more preferably from 1 to 200 μm. The edge of the film may be knurled on one or both surfaces thereof.

The width-direction difference of thickness except the knurled portion is preferably 5 μm or less, more preferably 3 μm or less. When a film having a length as great as more than 4,000 m, if the width-direction thickness difference thereof is great, is wound up, it is subject to deformation due to thickness difference called black belt. A sudden change of thickness over a narrow width is particularly disadvantageous in that it is not only viewed as abnormality in external appearance but also causes unevenness in brightness when the film is incorporated in a liquid crystal display device. It is preferred that when measured continuously in the crosswise direction, the thickness show no difference of more than 0.6 μm over a range of 10 mm at any measuring points and the thickness difference over a range of 10 mm be 0.5 μm or less.

In order to keep the cellulose acylate film of the invention transparent, the haze of the film is preferably from 0.01% to 2%. In order to reduce the haze of the film, the dispersion of particulate matting agent is sufficiently effected to reduce the number of agglomerated particles. In order to reduce the amount of particulate matting agent to be incorporated, the matting agent is incorporated in only the skin layer.

The invention further relates to a polarizing plate comprising the aforementioned cellulose acylate film provided therein as a protective film for polarizer.

### <Polarizing Plate>

A polarizing plate normally comprises a polarizer and two sheets of transparent protective layer disposed on the respective side thereof. In the invention, as at least one of the protective layers there is used a cellulose acylate film of the invention. As the other protective layer there may be used either a cellulose acylate film of the invention or an ordinary cellulose acylate film. Examples of the polarizer in polarizing film include iodine-based polarizers, dye-based polarizers comprising a dichromatic die, and polyene-based polarizers. The iodine-based polarizer and the dye-based polarizer are normally produced from a polyvinyl alcohol-based film. In the case where a cellulose acylate film of the invention is used as a protective layer for polarizing plate, the method of preparing the polarizing plate is not specifically limited but may be any ordinary method. For example, a method may be employed which comprises subjecting a cellulose acylate film obtained to alkaline treatment, and then sticking the cellulose acylate film to the both surfaces of a polarizer prepared by dipping and stretching a polyvinyl alcohol in an iodine solution with an aqueous solution of a fully-saponified polyvinyl alcohol. A processing for easy adhesion as disclosed in JP-A-6-94915 and JP-A-6-118232 may be effected instead of alkaline treatment. Examples of the adhesive with which the processed surface of the protective layer and the polarizer are stuck to each other include polyvinyl-based adhesives such as polyvinyl alcohol and polyvinyl butyral, and vinyl-based latexes such as butyl acrylate. The polarizing plate comprises a polarizer and a protective layer for protecting the both surfaces thereof. The polarizing plate may further have a protective film provided on one surface thereof and a separate film provided on the other. The protective film and the separate film are used for the purpose of protecting the surface of the polarizing plate during the shipment of the polarizing plate and during the inspection of the product. In this case, the protective film is stuck to the polarizing plate for the purpose of protecting the surface of the polarizing plate. The protective film is provided on the side of the polarizing plate opposite the side oil which it is stuck to the liquid crystal cell. The separate film is used for the purpose of covering the adhesive layer to be stuck to the liquid crystal cell. The separate film is provided on the side of the polarizing plate on which it is stuck to the liquid crystal plate.

Referring to the sticking of the stretched cellulose acylate film of the invention to the polarizer, the two components are preferably stuck to each other in such an arrangement that the transmission axis of the polarizer and the slow axis of the cellulose acylate film coincide with each other. In the polarizing plate prepared under polarizing plate crossed nicols, when the precision in right-angle crossing of the slow axis of the cellulose acylate film of the invention with the absorption axis of the polarizer (perpendicular to the transmission axis) is greater than 1°, the polarizing properties under polarizing plate crossed nicols are deteriorated to cause light leakage. When such a polarizing plate is combined with a liquid crystal cell, sufficient black level or contrast cannot be obtained. Accordingly, the deviation of the direction of the main refractive index nx of the cellulose acylate film of the invention from the direction of the transmission axis of the polarizing plate needs to be 1° or less, preferably 0.5° or less.

### <Surface Treatment>

The cellulose acylate film of the invention may be optionally subjected to surface treatment to attain the enhancement of the adhesion of the cellulose acylate film to the various functional layers (e.g., undercoat layer and back layer). Examples of the surface treatment employable herein include glow discharge treatment, irradiation with ultraviolet rays, corona treatment, flame treatment, and acid or alkaline treatment. The glow discharge treatment employable herein may involve the use of low temperature plasma developed under a low gas pressure of from 10⁻³ to 20 Torr, even more preferably plasma under the atmospheric pressure. The plasma-excitable gas is a gas which can be excited by plasma under the aforementioned conditions. Examples of such a plasma-excitable gas include argon, helium, neon, krypton, xenon, nitrogen, carbon dioxide, fluorocarbon such as tetrafluoromethane, and mixture thereof. For the details of these plasma-excitable gases, reference can be made to Kokai Giho No. 2001-1745, Mar. 15, 2001, pp. 30-32, Japan Institute of Invention and Innovation. In the plasma treatment under the atmospheric pressure, which has been recently noted, a radiation energy of from 20 to 500 kGy is used under an electric field of from 10 to 1,000 keV. Preferably, a radiation energy of from 20 to 300 kGy is used under an electric field of from 30 to 500 keV. Particularly preferred among these surface treatments is alkaline saponification, which is extremely effective for the surface treatment of the cellulose acylate film.

The alkaline saponification is preferably carried out by dipping the cellulose acylate film directly in a saponifying solution tank or by spreading a saponifying solution over the cellulose acylate film.

Examples of the coating method employable herein include dip coating method, curtain coating method, extrusion coating method, bar coating method, and E type coating method. As the solvent for the alkaline saponification coating solution there is preferably selected a solvent which exhibits good wetting properties and can keep the surface conditions of the cellulose acylate film good without roughening the surface thereof because the saponifying solution is spread over the cellulose acylate film. In some detail, an alcohol-based solvent is preferably used. An isopropyl alcohol is particularly preferred. Further, an aqueous solution of a surface active agent may be used as a solvent. The alkali of the alkaline saponification coating solution is preferably an alkali soluble in the aforementioned solvent, more preferably KOH or NaOH. The pH value of the saponification coating solution is preferably 10 or more, more preferably 12 or more. During the alkaline saponification, the reaction is preferably effected at room temperature for 1 second to 5 minutes, more preferably 5 seconds to 5 minutes, particularly 20 seconds to 3 minutes. The cellulose acylate film thus alkaline-saponified is preferably washed with water or an acid and then with water on the saponifying solution-coated surface thereof

### <Anti-Reflection Layer>

The transparent protective film provided on the polarizing plate on the side thereof opposite the liquid crystal cell preferably comprises a functional film such as anti-reflection film provided therein. In the invention in particular, an anti-reflection layer comprising a light-scattering layer and a low refractive index layer laminated on a protective layer in this order or an anti-reflection layer comprising a middle refractive index layer, a high refractive index layer and a low refractive index layer laminated on a protective layer in this order is preferably used. Preferred examples of such an anti-reflection layer will be given below.

A preferred example of the anti-reflection layer comprising a light-scattering layer and a low refractive index layer provided on a transparent protective layer will be described below.

The light-scattering layer according to the invention preferably has a particulate mat dispersed therein. The refractive index of the material of the light-scattering layer other than the particulate mat is preferably from 1.50 to 2.00. The refractive index of the low refractive index layer is preferably from 1.35 to 1.49. In the invention, the light-scattering layer has both anti-glare properties and hard coating properties. The light-scattering layer may be formed by a single layer or a plurality of layers such as two to four layers.

The anti-reflection layer is preferably designed in its surface roughness such that the central line average roughness Ra is from 0.08 to 0.40 μm, the ten point averaged roughness Rz is 10 times or less Ra, the average distance between mountain and valley Sm is from 1 to 100 μm, the standard deviation of the height of mountains from the deepest portion in roughness is 0.5 μm or less, the standard deviation of the average distance between mountain and valley Sm with central line as reference is 20 μm or less and the proportion of the surface having an inclination angle of from 0 to 5 degrees is 10% or more, making it possible to attain sufficient anti-glare properties and visually uniform matte finish.

Further, when the tint of reflected light under C light source comprises a* value of −2 to 2 and b* value of −3 to 3 and the ratio of minimum reflectance to maximum reflectance at a wavelength of from 380 nm to 780 nm is from 0.5 to 0.99, the tint of reflected light is neutral to advantage. Moreover, when the b* value of transmitted light under C light source is predetermined to range from 0 to 3, the yellow tint of white display for use in display devices is reduced to advantage.

Further, when a lattice of having a size of 120 μm×40 μm is disposed interposed between the planar light source and the anti-reflection film of the invention so that the standard deviation of brightness distribution measured over the film is 20 or less, glare developed when the film of the invention is applied to a high precision panel can be eliminated to advantage.

When the optical properties of the anti-reflection layer according to the invention are such that the specular reflectance is 2.5% or less, the transmission is 90% or more and the 60° gloss is 70% or less, the reflection of external light can be inhibited, making it possible to enhance the viewability to advantage. In particular, the specular reflectance is more preferably 1% or less, most preferably 0.5% or less. When the haze is from 20% to 50%, the ratio of inner haze to total haze is from 0.3 to 1, the reduction of haze from that up to the light-scattering layer to that developed after the formation of the low refractive index layer is 15% or less, the sharpness of transmitted image at an optical comb width of 0.5 mm is from 20% to 50% and the ratio of transmission of vertical transmitted light to transmission of transmitted light in the direction of 2 degrees from the vertical direction is from 1.5 to 5.0, the prevention of glare on a high precision LCD panel and the elimination of blurring of letters, etc. can be attained to advantage.

### <Low Refractive Index Layer>

The refractive index of the low refractive index layer employable herein is preferably from 1.20 to 1.49, more preferably from 1.30 to 1.44. Further, the low refractive index layer preferably satisfies the following numerical formula (XI) to advantage from the standpoint of reduction of reflectance.

(m/4)×0.7<n¹d¹<(m/4)×1.3 (XI)

wherein m represents a positive odd number; n¹ represents the refractive index of the low refractive index layer; and d¹ represents the thickness (nm) of the low refractive index layer. λ is a wavelength ranging from 500 to 550 nm.

The materials constituting the low refractive index layer according to the invention will be described hereinafter.

The low refractive index layer according to the invention preferably comprises a fluorine-containing polymer incorporated therein as a low refractive binder. As such a fluorine-based polymer there is preferably used a thermally or ionized radiation-crosslinkable fluorine-containing polymer having a dynamic friction coefficient of from 0.03 to 0.20, a contact angle of from 90 to 120° with respect to water and a purified water slip angle of 70° or less. As the peel force of the polarizing plate of the invention with respect to a commercially available adhesive tape during the mounting on the image display device decreases, the polarizing plate can be more easily peeled after the sticking of seal or memo to advantage. The peel force of the polarizing plate is preferably 5 N or less, more preferably 3 N or less, most preferably 1 N or less as measured by a tensile testing machine. The higher the surface hardness as measured by a microhardness meter is, the more difficulty can be damaged the low refractive index layer. The surface hardness of the low refractive index layer is preferably 0.3 GPa or more, more preferably 0.5 GPa or more.

Examples of the fluorine-containing polymer to be used in the low refractive index layer include hydrolyzates and dehydration condensates of perfluoroalkyl group-containing silane compounds (e.g., (heptadecafluoro-1,1,2,2-tetrahydrodecyl) triethoxysilane). Other examples of the fluorine-containing polymer include fluorine-containing copolymers comprising a fluorine-containing monomer unit and a constituent unit for providing crosslinking reactivity as constituent components.

Specific examples of the fluorine-containing monomers include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, Ltd.), and fully or partly fluorinated vinyl ethers. Preferred among these fluorine-containing monomers are perfluoroolefins. Particularly preferred among these fluorine-containing monomers is hexafluoropropylene from the standpoint of refractive index, solubility, transparency, availability, etc.

Examples of the constituent unit for providing crosslinking reactivity include constituent units obtained by the polymerization of monomers previously having a self-crosslinking functional group such as glycidyl (meth)acrylate and glycidyl vinyl ether, constituent units obtained by the polymerization of monomers having carboxyl group, hydroxyl group, amino group, sulfo group or the like (e.g., (meth)acrylic acid, methyl (meth)acrylate, hydroxylalkyl (meth)acrylate, allyl acrylate, hydroxyethyl vinyl ether, hydroxybutyl vinyl ether, maleic acid, crotonic acid), and constituent units obtained by introducing a crosslinking reactive group such as (meth)acryloyl group into these constituent units by a polymer reaction (e.g., by reacting acrylic acid chloride with hydroxyl group).

Besides the aforementioned fluorine-containing monomer units and constituent units for providing crosslinking reactivity, monomers free of fluorine atom may be properly copolymerized from the standpoint of solubility in the solvent, transparency of the film, etc. The monomer units which can be used in combination with the aforementioned monomer units are not specifically limited. Examples of these monomer units include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinyl ether, vinyl toluene, α-methyl styrene), vinylethers (e.g., methyl vinyl ether, ethyl vinyl ether, cyclohexyl vinyl ether), vinylesters (e.g., vinyl acetate, vinyl propionate, vinyl cinnamate), acrylamides (e.g., N-tert-butyl acrylamide, N-cyclohexyl acrylamide), methacrylamides, and acrylonitrile derivatives.

The aforementioned polymers may be used properly in combination with a hardener as disclosed in JP-A-10-25388 and JP-A-10-147739.

### <Light-Scattering Layer>

The light-scattering layer is formed for the purpose of providing the film with light-scattering properties developed by surface scattering and/or inner scattering and hard coating properties for the enhancement of scratch resistance of the film. Accordingly, the light-scattering layer comprises a binder for providing hard coating properties, a particulate mat for providing light diffusibility and optionally an inorganic filler for the enhancement of refractive index, the prevention of crosslink shrinkage and the enhancement of strength incorporated therein.

The thickness of the light-scattering layer is from 1 to 10 μm, more preferably from 1.2 to 6 μm from the standpoint of provision of hard coating properties and inhibition of generation of curling and worsening of brittleness.

The binder to be incorporated in the light-scattering layer is preferably a polymer having a saturated hydrocarbon chain or polyether chain as a main chain, more preferably a polymer having a saturated hydrocarbon chain as a main chain. The binder polymer preferably has a crosslinked structure. As the binder polymer having a saturated hydrocarbon chain as a main chain there is preferably used a (co)polymer of monomers having two or more ethylenically unsaturated groups. In order to provide the binder polymer with a higher refractive index, those containing an aromatic ring or at least one atom selected from the group consisting of halogen atoms other than fluorine, sulfur atom, phosphorus atom and nitrogen atom may be selected.

Examples of the monomer having two or more ethylenically unsaturated groups include esters of polyvalent alcohol with (meth)acrylic acid (e.g., ethylene glycol di(meth)acrylate, butanediol di(meth)acrylate, hexanediol di(meth)acrylate, 1,4-cyclohexanediacrylate, pentaerythritol tetra(meth)acrylate, pentaerythritol tri(meth)acrylate, trimethylolpropane tri(meth)acrylate, trimethylolethane tri(meth)acrylate, dipentaerythritol penta(meth)acrylate, dipentaerythritol tetra(meth)acrylate, dipentaerythritol penta(meth)acrylate, dipentaerithritol hexa(meth)acrylate, pentaerythritol hexa(meth)acrylate, 1,2,3-cyclohexane tetramethacrylate, polyurethane polyacrylate, polyester polyacrylate), modification products of the aforementioned ethylene oxides, vinylbenzene and derivatives thereof (e.g., 1,4-divinylbenzene, 4-vinyl benzoic acid-2-acryloylethylester, 1,4-divinyl cyclohexanone), vinylsulfones (e.g., divinylsulfone), acrylamides (e.g., methylenebisacrylamide), and methacrylamides. The aforementioned monomers may be used in combination of two or more thereof.

Specific examples of the high refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of the monomers having these ethylenically unsaturated groups can be effected by irradiation with ionized radiation or heating in the presence of a photo-radical polymerization initiator or heat-radical polymerization initiator.

Accordingly, an anti-reflection layer can be formed by a process which comprises preparing a coating solution containing a monomer having an ethylenically unsaturated group, a photo-polymerization initiator or heat radical polymerization initiator, a particulate mat and an inorganic filler, spreading the coating solution over the protective layer, and then irradiating the coat with ionized radiation or applying heat to the coat to cause polymerization reaction and curing. As such a photo-polymerization initiator or the like there may be used any compound known as such.

As the polymer having a polyether as a main chain there is preferably used an open-ring polymerization product of polyfunctional epoxy compound. The open-ring polymerization of the polyfunctional epoxy compound can be carried out by the irradiation of the polyfunctional epoxy compound with ionized radiation or applying heat to the polyfunctional epoxy compound in the presence of a photo-acid generator or heat-acid generator.

Accordingly, the anti-reflection layer can be formed by a process which comprises preparing a coating solution containing a polyfunctional epoxy compound, a photo-acid generator or heat-acid generator, a particulate mat and an inorganic filler, spreading the coating solution over the protective layer, and then irradiating the coat layer with ionized radiation or applying heat to the coat layer to cause polymerization reaction and curing.

Instead of or in addition to the monomer having two or more ethylenically unsaturated groups, a monomer having a crosslinkable functional group may be used to incorporate a crosslinkable functional group in the polymer so that the crosslinkable functional group is reacted to incorporate a crosslinked structure in the binder polymer.

Examples of the crosslinkable functional group include isocyanate group, epoxy group, aziridin group, oxazoline group, aldehyde group, carbonyl group, hydrazine group, carboxyl group, methylol group, and active methylene group. Vinylsulfonic acids, acid anhydrides, cyanoacrylate derivatives, melamines, etherified methylol, esters, urethane, and metal alkoxides such as tetramethoxysilane, too, may be used as monomers for introducing crosslinked structure. Functional groups which exhibit crosslinkability as a result of decomposition reaction such as block isocyanate group may be used. In other words, in the invention, the crosslinkable functional group may not be reactive as they are but may become reactive as a result of decomposition reaction.

These binder polymers having a crosslinkable functional group may be spread and heated to form a crosslinked structure.

The light-scattering layer comprises a particulate mat incorporated therein having an average particle diameter which is greater than that of filler particles and ranges from 1 to 10 μm, preferably from 1.5 to 7.0 μm, such as inorganic particulate compound and particulate resin for the purpose of providing itself with anti-glare properties.

Specific examples of the aforementioned particulate mat include inorganic particulate compounds such as particulate silica and particulate TiO₂, and particulate resins such as particulate acryl, particulate crosslinked acryl, particulate polystyrene, particulate crosslinked styrene, particulate melamine resin and particulate benzoguanamine resin. Preferred among these particulate resins are particulate crosslinked styrene, particulate crosslinked acryl, particulate crosslinked acryl styrene, and particulate silica. The particulate mat may be either spherical or amorphous.

Two or more particulate mats having different particle diameters may be used in combination. A particulate mat having a greater particle diameter may be used to provide the light-scattering layer with anti-glare properties. A particulate mat having a greater particle diameter may be used to provide the light-scattering layer with other optical properties.

Further, the distribution of the particle diameter of the mat particles is most preferably monodisperse. The particle diameter of the various particles are preferably as close to each other as possible. For example, in the case where a particle having a diameter of 20% or more greater than the average particle diameter is defined as coarse particle, the proportion of these coarse particles is preferably 1% or less, more preferably 0.1% or less, even more preferably 0.01% or less of the total number of particles. A particulate mat having a particle diameter distribution falling within the above defined range can be obtained by properly classifying the mat particles obtained by an ordinary synthesis method. By raising the number of classifying steps or intensifying the degree of classification, a matting agent having a better distribution can be obtained.

The aforementioned particulate mat is incorporated in the light-scattering layer in such a manner that the proportion of the particulate mat in the light-scattering layer is from 10 to 1,000 mg/m², more preferably from 100 to 700 mg/m².

For the measurement of the distribution of particle size of mat particles, a coulter counter method. The particle size distribution thus measured is then converted to distribution of number of particles.

The light-scattering layer preferably comprises an inorganic filler made of an oxide of at least one metal selected from the group consisting of titanium, zirconium, aluminum, indium, zinc, tin and antimony having an average particle diameter of 0.2 μm or less, preferably 0.1 μm or less, more preferably 0.06 μm or less incorporated therein in addition to the aforementioned particulate mat to enhance the refractive index thereof.

In order to enhance the difference of refractive index from the particulate mat, the light-scattering layer comprising a high refractive particulate mat incorporated therein preferably comprises a silicon oxide incorporated therein for keeping the refractive index thereof somewhat low. The preferred particle diameter of the particulate silicon oxide is the same as that of the aforementioned inorganic filler.

Specific examples of the inorganic filler to be incorporated in the light-scattering layer include TiO₂, ZrO₂, Al₂O₃, In₂O₃, ZnO, SnO₂, Sb₂O₃, ITO, and SiO₂. Particularly preferred among these inorganic fillers are TiO₂ and ZrO₂ from the standpoint of enhancement of refractive index. The inorganic filler is preferably subjected to silane coupling treatment or titanium coupling treatment on the surface thereof. To this end, a surface treatment having a functional group reactive with the binder seed on the surface thereof is preferably used.

The amount of the inorganic filler to be incorporated is preferably from 10 to 90%, more preferably from 20 to 80%, particularly from 30 to 75% based on the total mass of the light-scattering layer.

Such a filler has a particle diameter which is sufficiently smaller than the wavelength of light and thus causes no scattering. Thus, a dispersion having such a filler dispersed in a binder polymer behaves as an optically uniform material.

The bulk refractive index of the mixture of binder and inorganic filler in the light-scattering layer is preferably from 1.48 to 2.00, more preferably from 1.50 to 1.80. In order to predetermine the bulk refractive index of the mixture within the above defined range, the kind and proportion of the binder and the inorganic filler may be properly selected. How to select these factors can be previously easily known experimentally.

In order to keep the light-scattering layer uniform in surface conditions such as uniformity in coating and drying and prevention of point defects, the coating solution for forming the light-scattering layer comprises either or both of fluorine-based surface active agent and silicone-based surface active agent incorporated therein. In particular, a fluorine-based surface active agent is preferably used because it can be used in a smaller amount to exert an effect of eliminating surface defects such as unevenness in coating and drying and point defects of the anti-reflection film of the invention. Such a fluorine-based surface active agent is intended to render the coating solution adaptable to high speed coating while enhancing the uniformity in surface conditions, thereby raising the productivity.

The anti-reflection layer comprising a middle refractive index layer, a high refractive index layer and a low refractive index layer laminated on a protective layer in this order will be described hereinafter.

The anti-reflection layer comprising a layer structure having at least a middle refractive index layer, a high refractive index layer and a low refractive index layer (outermost layer) laminated on a substrate in this order is designed so as to have a refractive index satisfying the following relationship.

Refractive index of high refractive index layer>refractive index of middle refractive index layer>refractive index of transparent support>refractive index of low refractive index layer

Further, a hard coat layer may be provided interposed between the transparent support and the middle refractive index layer. Moreover, the anti-reflection layer may comprise a middle refractive hard coat layer, a high refractive index layer and a low refractive index layer laminated on each other (as disclosed in JP-A-8-122504, JP-A-8-110401, JP-A-10-300902, JP-A-2002-243906, and JP-A-2000-111706). Further, the various layers may be provided with other functions. Examples of these layers include stain-proof low refractive index layer, and antistatic high refractive index layer (as disclosed in JP-A-10-206603, JP-A-2002-243906).

The haze of the anti-reflection layer is preferably 5% or less, more preferably 30% or less. The strength of the anti-reflection layer is preferably not lower than H, more preferably not lower than 2H, most preferably not lower than 3H as determined by pencil hardness test method according to JIS K5400.

### <High Refractive Index Layer and Middle Refractive Index Layer>

The layer having a high refractive index in the anti-reflection layer is formed by a hardened layer containing at least a high refractive inorganic particulate compound having an average particle diameter of 100 nm or less and a matrix binder.

As the high refractive inorganic particulate compound there may be used an inorganic compound having a refractive index of 165 or more, preferably 1.9 or more. Examples of such a high refractive inorganic particulate compound include oxides of Ti, Zin, Sb, Sn, Zr, Ce, Ta, La and In, and composite oxides of these metal atoms.

In order to provide such a particulate material, the following requirements need to be satisfied. For example, the surface of the particles must be treated with a surface treatment (e.g., silane coupling agent as disclosed in JP-A-11-295503, JP-A-11-153703, and JP-A-2000-9908, anionic compound or organic metal coupling agent as disclosed in JP-A-2001-310432). Further, the particles must have a core-shell structure comprising a high refractive particle as a core (as disclosed in JP-A-2001-166104 and JP-A-2001-310432). A specific dispersant must be used at the same time (as disclosed in JP-A-11-153703, U.S. Pat. No. 6,210,858, JP-A-2002-2776069).

Examples of the matrix-forming materials include known thermoplastic resins, thermosetting resins, etc. Preferred examples of the matrix-forming materials include polyfunctional compound-containing compositions having two or more of at least any of radically polymerizable group and cationically polymerizable group, compositions having an organic metal compound containing a hydrolyzable group, and at least one selected from the group consisting of compositions containing a partial condensate thereof. Examples of these materials include compounds as disclosed in JP-A-2000-47004, JP-A-2001-315242, JP-A-2001-31871, and JP-A-2001-296401.

Further, a colloidal metal oxide obtained from a hydrolytic condensate of metal alkoxide and a curable layer obtained from a metal alkoxide composition are preferably used. For the details of these materials, reference can be made to JP-A-2001-293818.

The refractive index of the high refractive index layer is preferably from 1.70 to 2.20. The thickness of the high refractive index layer is preferably from 5 nm to 10 μm, more preferably from 10 nm to 1 μm.

The refractive index of the middle refractive index layer is adjusted so as to fall between the refractive index of the low refractive index layer and the high refractive index layer. The refractive index of the middle refractive index layer is preferably from 1.50 to 1.70. The thickness of the middle refractive index layer is preferably from 5 nm to 10 μm, more preferably from 10 nm to 1 μm.

### <Low Refractive Index Layer>

The low refractive index layer is laminated on the high refractive index layer. The refractive index of the low refractive index layer is preferably from 1.20 to 1.55, more preferably from 1.30 to 1.50.

The low refractive index layer is preferably designed as an outermost layer having scratch resistance and stain resistance. In order to drastically raise the scratch resistance of the low refractive index layer, a thin layer which can effectively provide surface slipperiness may be formed on the low refractive index layer by introducing a known silicone or fluorine thereinto.

The refractive index of the fluorine-containing compound is preferably from 1.35 to 1.50, more preferably from 1.36 to 1.47. As the fluorine-containing compound there is preferably used a compound containing a crosslinkable or polymerizable functional group having fluorine atoms in an amount of from 35 to 80% by mass.

Examples of such a compound include those disclosed in JP-A-9-222503, paragraphs [0018]-[0026], JP-A-11-38202, paragraphs [0019]-[0030], JP-A-2001-40284, paragraphs [0027]-[0028], and JP-A-2000-284102.

As the silicone compound there is preferably used a compound having a polysiloxane structure wherein a curable functional group or polymerizable functional group is incorporated in the polymer chain to form a bridged structure in the film. Examples of such a compound include reactive silicones (e.g., SILAPLANE, produced by CHISSO CORPORATION), and polysiloxanes having silanol group at both ends thereof (as disclosed in JP-A-11-258403).

In order to effect the crosslinking or polymerization reaction of at least any of fluorine-containing polymer and siloxane polymer having crosslinkable or polymerizable group, the coating composition for forming the outermost layer containing a polymerization initiator, a sensitizer, etc. is preferably irradiated with light or heated at the same time with or after spreading to form a low refractive index layer.

Further, a sol-gel cured film obtained by curing an organic metal compound such as silane coupling agent and a silane coupling agent containing a specific fluorine-containing hydrocarbon group in the presence of a catalyst is preferably used.

Examples of such a sol-gel cured film include polyfluoroalkyl group-containing silane compounds and partial hydrolytic condensates thereof (compounds as disclosed in JP-A-58-142958, JP-A-58-147483, JP-A-58-147484, JP-A-9-157582, and JP-A-11-106704), and silyl compounds having poly(perfluoroalkylether) group as a fluorine-containing long chain (compounds as disclosed in JP-A-2000-117902, JP-A-2001-48590, JP-A-2002-53804).

The low refractive index layer may comprise a filler (e.g., low refractive inorganic compound having a primary average particle diameter of from 1 to 150 nm such as particulate silicon dioxide (silica) and particulate fluorine-containing material (magnesium fluoride, calcium fluoride, barium fluoride), organic particulate material as disclosed in JP-A-11-3820, paragraphs [0020]-[0038]), a silane coupling agent, a lubricant, a surface active agent, etc. incorporated therein as additives other than the aforementioned additives.

In the case where the low refractive index layer is disposed under the outermost layer, the low refractive index layer may be formed by a gas phase method (vacuum metallizing method, sputtering method, ion plating method, plasma CVD method, etc.). A coating method is desirable because the low refractive index layer can be produced at reduced cost.

The thickness of the low refractive index layer is preferably from 30 to 200 nm, more preferably from 50 to 150 nm, most preferably from 60 to 120 nm.

Further, a hard coat layer, a forward scattering layer, a primer layer, an antistatic layer, an undercoating layer, a protective layer, etc. may be provided.

### <Hard Coat Layer>

The hard coat layer is normally provided on the surface of the protective layer to give a physical strength to the protective layer having an anti-reflection layer provided thereon. In particular, the hard coat layer is preferably provided interposed between the transparent support and the aforementioned high refractive index layer. The hard coat layer is preferably formed by the crosslinking reaction or polymerization reaction of a photosetting and/or thermosetting compound. The curable functional group in the curable compound is preferably a photopolymerizable functional group. Further, an organic metal compound or organic alkoxysilyl compound containing a hydrolyzable functional group is desirable.

Specific examples of these compounds include the same compounds as exemplified with reference to the high refractive index layer. Specific examples of the composition constituting the hard coat layer include those described in JP-A-2002-144913, JP-A-2000-9908, and WO00/46617.

The high refractive index layer may act also as a hard coat layer. In this case, particles may be finely dispersed in a hard coat layer in the same manner as described with reference to the high refractive index layer to form a high refractive index layer.

The hard coat layer may comprise particles having an average particle diameter of from 0.2 to 10 μm incorporated therein to act also as an anti-glare layer provided with anti-glare properties (described later).

The thickness of the hard coat layer may be properly designed depending on the purpose. The thickness of the hard coat layer is preferably from 0.2 to 10 μm, more preferably from 0.5 to 7 μm.

The strength of the hard coat layer is preferably not lower than H, more preferably not lower than 2H, most preferably not lower than 3H as determined by pencil hardness test according to JIS K5400. The abrasion of the test specimen is preferably as little as possible when subjected to taper test according to JIS K5400.

### <Antistatic Layer>

The antistatic layer, if provided, is preferably given an electrical conductivity of 10⁻⁸ (Ωcm⁻³) or less as calculated in terms of volume resistivity. The use of a hygroscopic material, a water-soluble inorganic salt, a certain kind of a surface active agent, a cation polymer, an anion polymer, colloidal silica, etc. makes it possible to provide a volume resistivity of 10⁻⁸ (Ωcm⁻³). However, these materials have a great dependence on temperature and humidity and thus cannot provide a sufficient electrical conductivity at low humidity. Therefore, as the electrically conductive layer material there is preferably used a metal oxide. Some metal oxides have a color. The use of such a colored metal oxide as an electrically conductive layer material causes the entire film to be colored to disadvantage. Examples of metal that forms a colorless metal oxide include Zn, Ti, Al, In, Si, Mg, Ba, Mo, W, and V. Metal oxides mainly composed of these metals are preferably used. Specific examples of these metal oxides include ZnO, TiO₂, SnO₂, Al₂O₃, In₂O₃, SiO₂, MgO, BaO, MoO₃, V₂O₅, and composites thereof. Particularly preferred among these metal oxides are ZnO, TiO₂, and SnO₂. Referring to the incorporation of different kinds of atoms, Al, In, etc. are effectively added to ZnO. Sb, Nb, halogen atoms, etc. are effectively added to SnO₂. Nb, Ta, etc. are effectively added to TiO₂. Further, as disclosed in JP-B-59-6235, materials comprising the aforementioned metal oxide attached to other crystalline metal particles or fibrous materials (e.g., titanium oxide) may be used. Volume resistivity and surface resistivity are different physical values and thus cannot be simply compared with each other. However, in order to provide an electrical conductivity of 10⁻⁸ (Ωcm⁻³) or less as calculated in terms of volume resistivity, it suffices if the electrically conductive layer has an electrical conductivity of 10⁻¹⁰ (Ω/□) or less, preferably 10⁻⁸ (Ω/□) or less, as calculated in terms of surface resistivity. It is necessary that the surface resistivity of the electrically conductive layer be measured when the antistatic layer is provided as an outermost layer. The measurement of surface resistivity can be effected at a step in the course of the formation of laminated film.

### <Liquid Crystal Display Device>

The cellulose acylate film of the invention and the polarizing plate comprising the cellulose acylate film can be used in liquid crystal cells and liquid crystal display devices of various display modes. Various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned) and HAN (Hybrid Aligned Nematic) have been proposed. Preferred among these display modes are OCB mode and VA mode.

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell. OCB mode liquid crystal cells are disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high response.

In a VA mode liquid crystal cell, rod-shaped liquid crystal molecules are vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode) (as disclosed in Preprints of Symposium on Japanese Liquid Crystal Society Nos. 58 to 59, 1998 and (4) liquid crystal cell of SURVALVAL mode (as reported in LCD International 98).

A VA mode liquid crystal display device comprises a liquid crystal cell and two sheets of polarizing plates disposed on the respective side thereof. In one embodiment of implementation of the transmission type liquid crystal display device of the invention, the cellulose acylate film of the invention is disposed interposed between the liquid crystal cell and one of the two polarizing plates or between the liquid crystal cell and the two sheets of polarizing plates.

In another embodiment of implementation of the transmission type liquid crystal display device of the invention, as the protective layer to be disposed between the liquid crystal cell and the polarizer there is used a cellulose acylate film of the invention. The aforementioned cellulose acylate film may be used only as the protective layer for one of the polarizing plates (between the liquid crystal cell and the polarizer). Alternatively, the aforementioned cellulose acylate film may be used as the protective layer for both the two polarizing plates (between the liquid crystal cell and the polarizer). In the case where the aforementioned cellulose acylate film is used only as one of the polarizing plates, it is preferably used as a protective film disposed on the liquid crystal cell side of the polarizing plate disposed on the back light side of the liquid crystal cell. The sticking of the cellulose acylate film to the liquid crystal cell is preferably effected such that the cellulose acylate film of the invention is disposed on VA cell side. The protective layer may be an ordinary cellulose acylate film and is preferably thinner than the cellulose acylate film of the invention. The thickness of the protective film is preferably from 40 to 80 μm. Examples of the protective film include commercially available products such as KC4UX2M (produced by Konica Minolta Opto Products Co., Ltd.; 40 μm), KC5UX (produced by Konica Minolta Opto Products Co., Ltd.; 60 μm) and TD80 (produced by Fuji Photo Film Co., Ltd.; 80 μm). However, the invention is not limited to these products.

### EXAMPLE

The invention will be further described in the following examples, but the invention is not limited thereto.

### Example 1

### Preparation of Cellulose Acylate Film

(1) Cellulose Acylate

Cellulose acylates having different degrees of acyl substitution set forth in Table 1 were prepared. In some detail, sulfuric acid was added as a catalyst (in an amount of 7.8 parts by mass based on 100 parts by mass of cellulose). A carboxylic acid was then added. The carboxylic acid was then subjected to acylation reaction at 40° C. Thereafter, the amount of sulfuric acid catalyst, the amount of water and the ripening time were adjusted to adjust the total substitution degree and the 6-position substitution degree. The ripening temperature was 40° C. The low molecular components of the cellulose acylate were then washed away with acetone.

(2) Preparation of Dope

### <1-1> Cellulose Acylate Solution

The following components were charged in a mixing tank where they were then stirred to make a solution which was heated to 90° C. for about 10 minutes, and then filtered through a filter paper having an average pore diameter of 34 μm and a sintered metal filter having an average pore diameter of 10 μm.

Cellulose acylate solution

| | | |
|---|---|---|
| Cellulose acylate set forth in Table 1 | 100.0 | parts by mass |
| Triphenyl phosphate | 8.0 | parts by mass |
| Biphenyl diphenyl phosphate | 4.0 | parts by mass |
| Methylene chloride | 403.0 | parts by mass |
| Methanol | 60.2 | parts by mass |

TABLE 1

| | | | | | 6-position |
|---|---|---|---|---|---|
| | | | | | substitution |
| | | Substitution | | | degree |
| | Substitution | degree of | Total | 6-position | Total |
| Raw cotton | degree of | propionyl | substitution | substitution | substitution |
| No. | acetyl group | group | degree | degree | degree |
| CA1 | 2.870 | 0.000 | 2.870 | 0.888 | 0.309 |
| CA2 | 2.810 | 0.000 | 2.810 | 0.895 | 0.319 |
| CA3 | 1.890 | 0.680 | 2.570 | 0.820 | 0.319 |

The term “total substitution degree” as used herein is meant to indicate the sum of degree of substitution in the 2-, 3- and 6-positions.

### <1-2> Matting Agent Dispersion

Subsequently, the following composition containing the cellulose acylate solution thus prepared was charged in a dispersing machine to prepare a matting agent dispersion.

Matting agent dispersion

| | |
|---|---|
| Particulate silica having average | 2.0 parts by mass |
| particle diameter of 16 nm (“Aerosil R972”, | |
| produced by Nippon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution A

Subsequently, the following composition containing the cellulose acylate solution prepared above was put in a mixing tank where it was then heated with stirring to make a solution as retardation developer solution A.

Retardation developer solution A

| | |
|---|---|
| Retardation developer A | 20.0 parts by mass |
| Methylene chloride | 58.3 parts by mass |
| Methanol | 8.7 parts by mass |
| Cellulose acylate solution | 12.8 parts by mass |

100 parts by mass of the aforementioned cellulose acylate solution, 1.35 parts by mass of the matting agent dispersion, and the retardation developer solution A in an amount set forth in Table 2 were mixed to prepare a film-making dope. The dope thus prepared was then used to prepare films F1, F2 and F4 to F8.

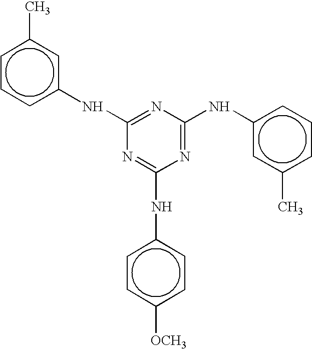

### <1-4> Retardation Developer Solution B

Further, the following composition containing the cellulose acylate solution prepared above was put in a mixing tank where it was then heated with stirring to make a solution as retardation developer solution B.

Retardation developer solution B

| | |
|---|---|
| Retardation developer A | 8.0 parts by mass |
| Retardation developer B | 12.0 parts by mass |
| Methylene chloride | 58.3 parts by mass |
| Methanol | 8.7 parts by mass |
| Cellulose acylate solution | 12.8 parts by mass |

100 parts by mass of the aforementioned cellulose acylate solution, 1.35 parts by mass of the matting agent dispersion, and the retardation developer solution B in an amount set forth in Table 2 were mixed to prepare a film-making dope. The dope thus prepared was then used to prepare a film F3.

The mixing proportion of the retardation developer is set forth in Table 2 as calculated in terms of parts by mass based on 100 parts by mass of cellulose acylate.

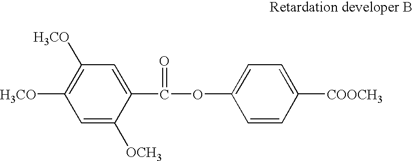

### (Casting)

The aforementioned dopes were each then casted using a band casting machine. The films thus formed were each then peeled off the band when the amount of residual solvent was from 25% to 35% by mass. Using a tenter, the films thus peeled were each then crosswise stretched at a draw ratio of from 15% to 35% (set forth in Table 2) to prepare a cellulose acylate film.

TABLE 2

| | | | Added amount | | | |
|---|---|---|---|---|---|---|
| | Raw | Retardation | of retardation | | Film | |
| Film | cotton | developer | developer | % | thickness | |
| No. | No. | solution | (parts by mass) | Stretching | (μm) | Remarks |
| F1 | CA2 | A | 6.5 | 25 | 92 | Inventive |
| F2 | CA2 | A | 7.0 | 16 | 92 | Inventive |
| F3 | CA2 | B | 7.2 | 25 | 92 | Inventive |
| F4 | CA1 | A | 4.5 | 20 | 92 | Inventive |
| F5 | CA1 | A | 3.0 | 35 | 92 | Comparative |
| F6 | CA3 | A | 3.0 | 25 | 82 | Inventive |
| F7 | CA3 | A | 6.0 | 20 | 82 | Inventive |
| F8 | CA3 | — | 0.0 | 35 | 80 | Comparative |

The cellulose acylate films thus obtained were each then measured for absorbance developed when the polarizing surface is perpendicular to the surface on which light is incident (ATEx) and absorbance developed when the polarizing surface is parallel to the surface on which light is incident (ATMx) under the aforementioned conditions by polarized ATR method (measuring instrument: FTS7000 (produced by Varian)) when light was incident parallel to the longitudinal direction of the film thus prepared. Subsequently, ATEy and ATMy were similarly measured when light was incident parallel to the width direction of the film. These factors were then substituted in the aforementioned equation to calculate fxy (in-plane orientation coefficient) and fxz (thickness-direction orientation coefficient) as previously mentioned. The results are set forth in Table 3 below.

The cellulose acylate films thus prepared (optically-compensatory sheet) were each measured for Re retardation value and Rth retardation value at 25° C.-60% RH and a wavelength of 590 nm using a Type KOBRA 21ADH birefringence meter (produced by Ouji Scientific Instruments Co., Ltd.). These films were each moisture-conditioned to 25° C.-10% RH and 25° C.-80% RH for 2 hours, and then measured for Re retardation value and Rth retardation value at a wavelength of 590 nm. Supposing that the change of retardation value of cellulose acylate film from at 80% RH to at 10% RH (Re(10% RH)-Re(80% RH), Rth(10% RH)-Rth(80% RH)) are ΔRe and ΔRth, respectively, the ratio ΔRe/Re and ΔRth/Rth of ΔRe and ΔRth to Re retardation value and Rth retardation value measured at 25° C.-60% RH, respectively, are set forth in Table 3 below.

TABLE 3

| Film | | | | ΔRe/ | | ΔRth/ | |
|---|---|---|---|---|---|---|---|
| No. | fxy | fxz | Re(nm) | Re | Rth(nm) | Rth | Remarks |
| F1 | −0.070 | −0.014 | 73 | 0.08 | 226 | 0.11 | Inventive |
| F2 | −0.040 | 0.080 | 42 | 0.06 | 215 | 0.11 | Inventive |
| F3 | −0.070 | −0.020 | 69 | 0.10 | 215 | 0.13 | Inventive |
| F4 | −0.060 | 0.060 | 32 | 0.22 | 157 | 0.21 | Inventive |
| F5 | −0.150 | −0.150 | 45 | 0.33 | 147 | 0.27 | Comparative |
| F6 | −0.100 | −0.030 | 45 | 0.11 | 130 | 0.11 | Inventive |
| F7 | −0.050 | −0.020 | 65 | 0.08 | 200 | 0.10 | Inventive |
| F8 | −0.200 | −0.250 | 50 | 0.28 | 120 | 0.19 | Comparative |

As can be seen in the results of Table 3, all the inventive films F1 to F4, F6 and F7, which have a low orientation coefficient, exhibited a high Re retardation value and Rth retardation value but exhibited a small change of retardation values with atmospheric humidity as compared with the comparative film F5 and F8, which has a high orientation coefficient.

### Example 2

<2-1-1>

### (Preparation-1 of Polarizing Plate)

Iodine was adsorbed to the polyvinyl alcohol film thus stretched to prepare a polarizer.

The cellulose acylate films prepared in Example 1 (F1 to F8: corresponding to TAC1 of FIGS. 2 to 4) were each then stuck to one side of the polarizer with a polyvinyl alcohol-based adhesive. The saponification of these cellulose acylate films was effected under the following conditions.

A 1.5 N aqueous solution of sodium hydroxide was prepared and kept at 55° C. A 0.01 N diluted aqueous solution of sulfuric acid was prepared and kept at 35° C. The cellulose acylate films prepared above were each dipped in the aqueous solution of sodium hydroxide for 2 minutes, and then dipped in water so that the aqueous solution of sodium hydroxide was thoroughly removed. Subsequently, the cellulose acylate films were each dipped in the diluted sulfuric acid for 1 minute, and then dipped in water so that the diluted sulfuric acid was thoroughly removed, Finally, the samples were each thoroughly dried at 120° C.

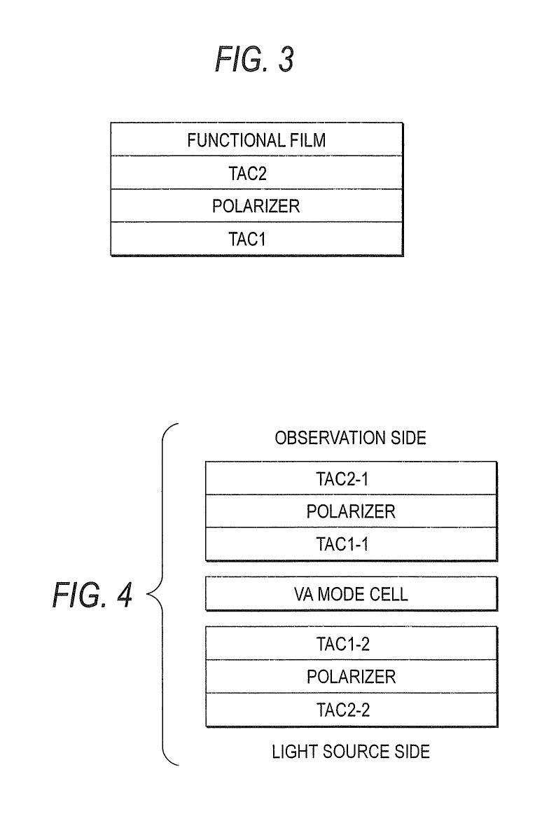

A commercially available cellulose triester film (Fujitac TD80UF, produced by Fuji Photo Film Co., Ltd. corresponding to functional film TAC2 of FIG. 3 and TAC2-1 or 2-2 of FIG. 4) was subjected to saponification, and then stuck to the other side of the polarizer with a polyvinyl alcohol-based adhesive. The laminate was then dried at 70° C. for 10 minutes.

The arrangement was made such that the transmission axis of the polarizer and the slow axis of the cellulose acylate film prepared in Example 1 were parallel to each other (FIG. 2) and the transmission axis of the polarizer and the slow axis of the commercially available cellulose triester film were perpendicular to each other.

<2-2-1>

### (Preparation of Coating Solution for Light-Scattering Layer)

50 g of a mixture of pentaerythritol triacrylate and pentaerythritol tetraacryalte (PETA, produced by NIPPON KAYAKU CO., LTD.) was diluted with 38.5 g of toluene. To the solution was then added 2 g of a polymerization initiator (Irgacure 184, produced by Ciba Geigy Specialty Chemicals Co., Ltd.). The mixture was then stirred. The refractive index of the coat layer obtained by spreading and ultraviolet-curing the solution was 1.51.

To the solution were then added 1.7 g of a 30% toluene dispersion of a particulate crosslinked polystyrene having an average particle diameter of 3.5 μm (refractive index: 1.60; SX-350, produced by Soken Chemical & Engineering Co., Ltd.) and 13.3 g of a 30% toluene dispersion of a particulate crosslinked acryl-styrene having an average particle diameter of 3.5 μm (refractive index: 1.55, produced by Soken Chemical & Engineering Co, Ltd.) which had both been dispersed at 10,000 rpm by a polytron dispersing machine for 20 minutes. Finally, to the solution were added 0.75 g of the following fluorine-based surface modifier (FP-1) and 10 g of a silane coupling agent (KBM-5103, produced by Shin-Etsu Chemical Co., Ltd.) to obtain a completed solution.

The aforementioned mixed solution was then filtered through a polypropylene filter having a pore diameter of 30 μm to prepare a light-scattering layer coating solution.

<2-2-2>

### (Preparation of Coating Solution for Low Refractive Index Layer)

Firstly, a sol a was prepared in the following manner. In some detail, 120 parts of methyl ethyl ketone, 100 parts of an acryloyloxypropyl trimethoxysilane (KBM5103, produced by Shin-Etsu Chemical Co., Ltd.) and 3 parts of diisopropoxyaluminum ethyl acetoacetate were charged in a reaction vessel equipped with an agitator and a reflux condenser to make mixture. To the mixture were then added 30 parts of deionized water. The mixture was reacted at 60° C. for 4 hours, and then allowed to cool to room temperature to obtain a sol a. The mass-average molecular mass of the sol was 1,600. The proportion of components having a molecular mass of from 1,000 to 20,000 in the oligomer components was 100%. The gas chromatography of the sol showed that no acryloyloxypropyl trimethoxysilane which is a raw material had been left. 13 g of a thermally-crosslinkable fluorine-containing polymer (JN-7228; solid concentration: 6%; produced by JSR Co., Ltd.) having a refractive index of 1.42, 1.3 g of silica sol (silica having a particle size different from that MEK-ST; average particle size: 45 nm; solid concentration: 30%, produced by NISSAN CHEMICAL INDUSTRIES, LTD.), 0.6 g of the sol a thus prepared, 5 g of methyl ethyl ketone and 0.6 g of cyclohexanone were mixed with stirring. The solution was then filtered through a polypropylene filter having a pore diameter of 1 μm to prepare a low refractive index layer coating solution.

<2-2-3>
(Preparation of Transparent Protective Film 01 with Light-Scattering Layer)

The aforementioned coating solution for functional layer (light-scattering layer) was spread over a triacetyl cellulose film having a thickness of 80 μm (Fujitac TD80UF, produced by Fuji Photo Film Co., Ltd.) which was being unwound from a roll at a gravure rotary speed of 30 rpm and a conveying speed of 30 m/min using a microgravure roll with a diameter of 50 mm having 180 lines/inch and a depth of 40 μm and a doctor blade. The coated film was dried at 60° C. for 150 seconds, irradiated with ultraviolet rays at an illuminance of 400 mW/cm² and a dose of 250 mJ/cm² from an air-cooled metal halide lamp having an output of 160 W/cm (produced by EYE GRAPHICS CO., LTD.) in an atmosphere in which the air within had been purged with nitrogen so that the coat layer was cured to form a functional layer to a thickness of 6 μm. The film was then wound.

The coating solution for low refractive layer thus prepared was spread over the triacetyl cellulose film having the functional layer (light-scattering layer) provided thereon was being unwound at a gravure rotary speed of 30 rpm and a conveying speed of 15 m/min using a microgravure roll with a diameter of 50 mm having 180 lines/inch and a depth of 40 μm and a doctor blade. The coated film was dried at 120° C. for 150 seconds and then at 140° C. for 8 minutes. The film was irradiated with ultraviolet rays at an illuminance of 400 mW/cm² and a dose of 900 mJ/cm² from an air-cooled metal halide lamp having an output of 240 W/cm (produced by EYE GRAPHICS CO., LTD.) in an atmosphere in which the air within had been purged with nitrogen to form a low refractive layer to a thickness of 100 nm. The film was then wound (corresponding to functional film TAC2 of FIG. 3 or TAC2-1 of FIG. 4).

<2-3-1>

### (Preparation-2 of Polarizing Plate)

Iodine was adsorbed to the polyvinyl alcohol film thus stretched to prepare a polarizer.

The transparent protective film 01 with light-scattering layer prepared above was subjected to saponification in the same manner as in <2-1-1>, and then stuck to one side of the polarizer on the side thereof free of functional film.

The cellulose acylate films prepared in Example 1 (F1 to F5: corresponding to TAC1 of FIG. 2) was subjected to saponification in the same manner as mentioned above, stuck to the other side of the polarizer with a polyvinyl alcohol-based adhesive, and then dried at 70° C. for 10 minutes or more (for completed configuration, see FIG. 3).

The transmission axis of the polarizer and the slow axis of the cellulose acylate film prepared in Example 1 were disposed parallel to each other (FIG. 2). The transmission axis of the polarizer and the slow axis of the transparent protective film 01 with light-scattering layer were disposed perpendicular to each other. In this arrangement, polarizing plates (B1 to B5: functional film-optically compensatory film integrated polarizing plate (FIG. 3)) were prepared.

Iodine was adsorbed to the polyvinyl alcohol film thus stretched to prepare a polarizer. The transparent protective film 01 with light-scattering layer prepared in <2-2-3> and a triacetyl cellulose film having a thickness of 80 μm free of functional layer (Fujitac TD80UF, produced by Fuji Photo Film Co., Ltd.) were subjected to saponification in the same manner as mentioned above, and then stuck to the polarizer with a polyvinyl alcohol-based adhesive in the same manner as mentioned above. In this manner, a polarizing plate (B0: functional film-optically compensatory film integrated polarizing plate (FIG. 3)) was prepared.

Using a spectrophotometer (produced by JASCO Corporation), these polarizing plates were each then measured for spectral reflectance on the functional layer side thereof at an incidence angle of 5° and a wavelength of from 380 nm to 780 nm to determine an integrating sphere average reflectance at 450 nm to 650 nm. As a result, these polarizing plates exhibited an integrating sphere average reflectance of 2.3%.

<2-4-1>

### (Preparation of Coating Solution for Hard Coat Layer)

To 750.0 parts by mass of a trimethylolpropane triacrylate (TMPTA, produced by NIPPON KAYAKU CO., LTD.) were added 270.0 parts by mass of a poly(glycidyl methacrylate) having a mass-average molecular mass of 3,000, 730.0 g of methyl ethyl ketone, 500.0 g of cyclohexanone and 50.0 g of a photopolymerization initiator (Irgacure 184, produced by Ciba Geigy Japan Inc.). The mixture was then stirred. The mixture was then filtered through a polypropylene filter having a pore diameter of 0.4 μm to prepare a hard coat layer coating solution.

<2-4-2>

### (Preparation of Fine Dispersion of Particulate Titanium Dioxide)

As the particulate titanium dioxide there was used a particulate titanium dioxide containing cobalt surface-treated with aluminum hydroxide and zirconium hydroxide (MPT-129, produced by ISHIHARA SANGYO KAISHA, LTD.).

To 257.1 g of the particulate titanium dioxide were then added 38.6 g of the following dispersant and 704.3 g of cyclohexanone. The mixture was then dispersed using a dinomill to prepare a dispersion of titanium dioxide particles having a mass-average particle diameter of 70 nm.

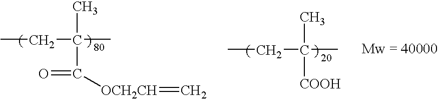

<2-4-3>

### (Preparation of Middle Refractive Index Layer Coating Solution)

To 88.9 g of the aforementioned dispersion of titanium dioxide particles were added 58.4 g of a mixture of dipentaerytritol petaacrylate and dipentaerythritol hexaacrylate (DPHA), 3.1 g of a photopolymerization initiator (Irgacure 907), 1.1 g of a photosensitizer (Kayacure DETX, produced by NIPPON KAYAKU CO., LTD.), 482.4 g of methyl ethyl ketone and 1,869.8 g of cyclohexanone. The mixture was then stirred. The mixture was thoroughly stirred, and then filtered through a polypropylene filter having a pore diameter of 0.4 μm to prepare a middle refractive index layer coating solution.

<2-4-4>

### (Preparation of High Refractive Index Layer Coating Solution)

To 586.8 g of the aforementioned dispersion of titanium dioxide particles were added 47.9 g of a mixture of dipentaerytritol petaacrylate and dipentaerythritol hexaacrylate (DPHA), 4.0 g of a photopolymerization initiator (Irgacure 907), 1.3 g of a photosensitizer (Kayacure DETX, produced by NIPPON KAYAKU CO., LTD.), 455.8 g of methyl ethyl ketone and 1,427.8 g of cyclohexanone. The mixture was then stirred. The mixture was thoroughly stirred, and then filtered through a polypropylene filter having a pore diameter of 0.4 μm to prepare a high refractive index layer coating solution.

<2-4-5>

### (Preparation of Low Refractive Index Layer Coating Solution)

The copolymer having the following structure was dissolved in methyl isobutyl ketone in such an amount that the concentration reached 7% by mass. To the solution were then added a methacrylate group-terminated silicone resin X-22-164C (produced by Shin-Etsu Chemical Co., Ltd.) and a photoradical generator Irgacure 907 (trade name) in an amount of 3% and 5% by mass based on the solid content, respectively, to prepare a low refractive index layer coating solution.

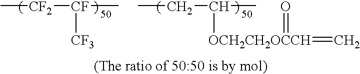

<2-4-6>
(Preparation of Transparent Protective Film 02 with Anti-Reflection Layer)

A hard coat layer coating solution was spread over a triacetyl cellulose film having a thickness of 80 μm (Fujitack TD80UF, produced by Fuji Photo Film Co., Ltd.) using a gravure coater. The coated film was dried at 100° C., and then irradiated with ultraviolet rays at an illuminance of 400 mW/cm² and a dose of 300 mJ/cm² from an air-cooled metal halide lamp having an output of 160 W/cm (produced by EYE GRAPHICS CO., LTD.) in an atmosphere in which the air within had been purged with nitrogen to reach an oxygen concentration of 1.0 vol-% so that the coat layer was cured to form a hard coat layer to a thickness of 8 μm.

The middle refractive index layer coating solution, the high refractive index layer coating solution and the low refractive index layer coating solution were continuously spread over the hard coat layer using a gravure coater having three coating stations.

The drying conditions of the middle refractive index layer were 100° C. and 2 minutes. Referring to the ultraviolet curing conditions, the air in the atmosphere was purged with nitrogen so that the oxygen concentration reached 1.0 vol-%. In this atmosphere, ultraviolet rays were emitted at an illuminance of 400 mW/cm² and a dose of 400 mJ/cm² by an air-cooled metal halide lamp having an output of 180 W/cm (produced by EYE GRAPHICS CO., LTD.). The middle refractive index layer thus cured had a refractive index of 1.630 and a thickness of 67 nm.

The drying conditions of the high refractive index layer and the low refractive index layer were 90° C. and 1 minute followed by 100° C. and 1 minute. Referring to the ultraviolet curing conditions, the air in the atmosphere was purged with nitrogen so that the oxygen concentration reached 1.0 vol-%. In this atmosphere, ultraviolet rays were emitted at an illuminance of 600 mW/cm² and a dose of 600 mJ/cm² by an air-cooled metal halide lamp having an output of 240 W/cm (produced by EYE GRAPHICS CO., LTD.).

The high refractive layer thus cured had a refractive index of 1.905 and a thickness of 107 nm and the low refractive layer thus cured had a refractive index of 1.440 and a thickness of 85 nm. Thus, a transparent protective film 02 with anti-reflection layer was prepared (corresponding to TAC2 of FIG. 3 or TAC2-1 of FIG. 3).

<2-5-1>

### (Preparation-3 of Polarizing Plate)

Polarizing plates (C1 to C5: functional film-optically compensatory film integrated polarizing plate (FIG. 3)) were prepared in the same manner as in <2-3-1> except that the transparent protective film 02 with anti-reflection layer was used instead of the transparent protective film 01 with anti-reflection layer. This preparation method was followed to prepare a polarizing plate (C0) comprising the transparent protective film 02 with anti-reflection layer, a polarizer and a triacetyl cellulose film having a thickness of 80 μm free of functional layer (Fujitac TD80UF, produced by Fuji Photo Film Co., Ltd.).

Using a spectrophotometer (produced by JASCO Corporation), these polarizing plates were each then measured for spectral reflectance on the functional layer side thereof at an incidence angle of 5° and a wavelength of from 380 nm to 780 nm to determine an integrating sphere average reflectance at 450 nm to 650 nm. As a result, these polarizing plates exhibited an integrating sphere average reflectance of 0.4%.

### Example 3

### Mounting on Panel

### <Preparation of Liquid Crystal Cell>

A liquid crystal cell was prepared by injecting a liquid crystal material having a negative dielectric anisotropy (“MLC6608”, produced by Melc Co, Ltd.) into substrates apart from each other at a distance (cell gap) of 3.6 μm to prepare a liquid crystal layer therebetween. The retardation of the liquid crystal layer (i.e., product Δn·d of the thickness d (μm) and the refractive anisotropy Δn of the liquid crystal layer) was 300 nm. The liquid crystal material was vertically aligned.

As the upper polarizing plate (observation side) for the liquid crystal display device (FIG. 4) comprising the aforementioned vertically-aligned liquid crystal cell there was used a commercially available super high contrast product (e.g., HLC2-5618, produced by Sanritz Corporation). As the lower polarizing plate there was provided each of the polarizing plates (A1 to A5) prepared in <2-1-1> of Example 2 from the optically-compensatory sheets F1 to F8 prepared in Example 1 in such an arrangement that the cellulose acylate film prepared in Example 1 (corresponding to TAC1-2 of FIG. 4) was disposed on the liquid crystal cell side. In this manner, liquid crystal display devices P1 to P8 were prepared. The sticking of the upper polarizing plate and the lower polarizing plate to the liquid crystal cell was effected with an adhesive. The arrangement was made in crossed nicols such that the transmission axis of the upper polarizing plate was aligned vertically and the transmission axis of the lower polarizing plate was aligned horizontally.

### Mounting on VA Panel 1

A liquid crystal display device of FIG. 4 was prepared by using A1 to A3 and A7. In some detail, an upper polarizing plate (TAC2-1 (with functional film/free of functional film)), polarizer, TAC1-1), a VA mode liquid crystal cell and a lower polarizing plate (TAC1-2, polarizer, TAC2-2) were laminated in this order as viewed in the viewing direction (from above). A backlight source was then disposed on the laminate. While the following example will be described with reference to the case where as the upper polarizing plate there is used a commercially available polarizing plate (HLC2-5618) and as the lower polarizing plate there is used a polarizing plate integrated with an optically-compensatory film, there arise no problems even if the aforementioned configuration is inversed. However, it is more likely that the integrated polarizing plate can be used as the lower polarizing plate (This is because when the integrated polarizing plate is used as the upper polarizing plate, the functional film needs to be disposed on the observation side (upper side), making it likely that the productivity can be lowered). It is thus thought that the following configuration is a preferred embodiment.

### Example 4

### Mounting on VA panel 2

A liquid crystal display devices were prepared by the same way as Example 3 except for using A4 to A6 and A8 in both of upper side and lower side of a liquid crystal cell in a construction shown in FIG. 4 and placing cellulose acylate films prepared in Example 1 in liquid crystal cell side (which corresponds to TAC1-1 and TAC1-2 of FIG. 4).

These panels were each then measured for contrast at an azimuthal angle of 45° from the horizontal direction of the liquid crystal display screen and a polar angle of 60° from the line normal to the surface of screen and xy chromaticity during black display at 25° C. and 60% RH using a Type EZ-Contrast160D measuring instrument (produced by ELDIM Inc.). The results are set forth in Table 4 below. Subsequently, these panels were each allowed to stand in a 25° C.-10% RH room for 1 week, and then measured for contrast value and xy chromaticity during black display in the same manner as mentioned above. Subsequently, these panels were each allowed to stand in a 25° C.-80% RH room for 1 week, and then measured for contrast value and xy chromaticity during black display in the same manner as mentioned above. The change of these values from the initial values at 60% RH are set forth in Table 4 below. As can be seen in Table 4, the inventive products show a small change of contrast value and xy chromaticity.

TABLE 4

| Liquid | Contrast value at | | | | | | | | |
|---|---|---|---|---|---|---|---|---|---|
| crystal | azimuthal angle of | Contrast value | | xy chromaticity | | xy chromaticity | | xy chromaticity | |
| display | 45° and polar | change | | during black display | | change at 10% RH | | change 80% RH | |
| device No. | angle of 60° | 10% RH | 80% RH | x | y | x | y | x | y |
| P1 | 50 | −3 | −3 | 0.340 | 0.290 | 0.010 | 0.006 | 0.015 | 0.005 |
| P2 | 42 | −3 | −2 | 0.310 | 0.300 | 0.007 | 0.005 | 0.010 | 0.009 |
| P3 | 50 | −5 | −4 | 0.320 | 0.270 | 0.011 | 0.010 | 0.012 | 0.012 |
| P4 | 40 | −6 | −5 | 0.300 | 0.310 | 0.020 | 0.012 | 0.018 | 0.012 |
| P5 | 43 | −14 | −12 | 0.330 | 0.290 | 0.060 | 0.020 | 0.080 | 0.033 |
| P6 | 35 | −10 | −8 | 0.320 | 0.300 | 0.040 | 0.020 | 0.030 | 0.020 |
| P7 | 40 | −5 | −3 | 0.300 | 0.270 | 0.010 | 0.006 | 0.010 | 0.006 |
| P8 | 35 | −15 | −12 | 0.330 | 0.310 | 0.070 | 0.020 | 0.020 | 0.030 |

### INDUSTRIAL APPLICABILITY

The cellulose acylate film of the invention can provide an optical film having an excellent developability of in-plane retardation and thickness-direction retardation and little change of retardation value with environmental factors such as humidity.

The polarizing plate of the invention can provide a liquid crystal display device having little change of viewing angle properties even with the change of atmospheric humidity. Thus, the liquid crystal display device of the invention shows little change of viewing angle properties even with the change of atmospheric humidity.

The entire disclosure of each and every foreign patent application from which the benefit of foreign priority has been claimed in the present application is incorporated herein by reference, as if fully set forth.

1. A cellulose acylate film that has: an in-plane orientation coefficient fxy and a thickness-direction orientation coefficient fxz falling within a range represented by following relationships; and an in-plane retardation Re (λ) falling within a range of 30 nm≦Re (590)≦200 nm and a thickness-direction retardation Rth (λ) falling within a range of 70 nm≦Rth (590)≦350 nm at 25° C., 60% RH:

|fxy|<0.15

|fxz|<0.15
wherein fxy and fxz are calculated from infrared absorption spectroscopy measurement data based on C═O expansion/contraction mode of a ester group, and
wherein Re (λ) represents an in-plane retardation (Re) value (unit: nm) at a wavelength of λ nm; and
Rth (λ) represents a thickness-direction retardation (Rth) value (unit: nm) at a wavelength of λ nm.

2. The cellulose acylate film according to claim 1,
wherein a difference ΔRe (=Re10% RH-Re80% RH) between Re (590) (Re10% RH) at 25° C., 10% RH and Re (590) (Re80% RH) at 25° C., 80% RH and Re (590) (Re60% RH) at 25° C., 60% RH satisfy a relationship |ΔRe/Re60% RH|≦0.25, and
wherein a difference ΔRth (=Rth10% RH-Rth80% RH) between Rth (590) (Rth10% RH) at 25° C., 10% RH and Rth (590) (Rth80% RH) at 25° C., 80% RH and Rth (590) (Rth60% RH) at 25° C., 60% RH satisfy a relationship |ΔRth/Rth60% RH|≦0.25.

3. The cellulose acylate film according to claim 1, which comprises at least one retardation developer containing a rod-shaped compound or a disc-shaped compound in an amount of from 3% to 20% by mass based on a mass of the cellulose acylate film.

4. The cellulose acylate film according to claim 1, which is stretched at a draw ratio of from 1.01 to 1.3.

5. The cellulose acylate film according to claim 1, which is a film comprising a cellulose acylate obtained by substituting hydroxyl groups in a glucose unit constituting a cellulose by an acyl group having two or more carbon atoms,
wherein supposing that a degree of substitution of 2-position of a glucose unit by a hydroxyl group is DS2, a degree of substitution of 3-position of a glucose unit by a hydroxyl group is DS3 and a degree of substitution of 6-position of a glucose unit by a hydroxyl group is DS6, DS2, DS3 and DS6 satisfy following relationships (I) and (II).
2.55≦DS2+DS3+DS6≦2.85 (I)
DS6/(DS2+DS3+DS6)≦0.315 (II)

6. The cellulose acylate film according to claim 1, which comprises at least one of a plasticizer, an ultraviolet absorber and a peel accelerator.

7. The cellulose acylate film according to claim 1,
wherein the cellulose acylate film has a thickness of from 40 μm to 180 μm.

8. A polarizing plate comprising:
a polarizer; and
at least one protective film for the polarizer,
wherein at least one of the at least one protective film is a cellulose acylate film according to claim 1.

9. The polarizing plate according to claim 8, which further comprises at least one of a hard coat layer, an anti-glare layer and an anti-reflection layer provided on a surface of a protective film disposed on a side of the polarizing plate opposite to a liquid crystal cell.

10. A liquid crystal display device comprising at least one of a cellulose acylate film according to claim 1 and a polarizing plate comprising: a polarizer, and at least one protective film for the polarizer, wherein at least one of the at least one protective film is a cellulose acylate film according to claim 1.

11. The liquid crystal display device according to claim 10, which is an OCB mode.

12. The liquid crystal display device according to claim 10, which is a VA mode.

13. A VA mode liquid crystal display device comprising at least one of a cellulose acylate film according to claim 1 and a polarizing plate comprising: a polarizer; and at least one protective film for the polarizer, wherein at least one of the at least one protective film is a cellulose acylate film according to claim 1.

14. The VA mode liquid crystal display device according to claim 13,
wherein the at least one of a cellulose acylate film according to claim 1 and a polarizing plate comprising: a polarizer; and at least one protective film for the polarizer, wherein at least one of the at least one protective film is a cellulose acylate film according to claim 1 is provided on a back light side.
